(19) United States
(12) Patent Application Publication
(10) Pub. No.: US 2023/0114036 A1
(43) Pub. Date: Apr. 13, 2023

(54) Low-Cost High-Purity Vacuum Pumps and Systems

(71) Applicant: Desktop Metal, Inc., Burlington, MA (US)

(72) Inventor: Nathan Woodard, Medford, MA (US)

(73) Assignee: Desktop Metal, Inc., Burlington, MA (US)

(21) Appl. No.: 17/802,722

(22) PCT Filed: Mar. 1, 2021
(86) PCT No.: PCT/US2021/020347

§ 371 Date: Aug. 26, 2022

Related U.S. Application Data
(60) Provisional application No. 62/983,281, filed on Feb. 28, 2020.

(51) Int. Cl. F27B 5/04; B22F 3/00; F27B 5/16

(52) U.S. Cl. CPC F27B 5/04; B22F 3/003; F27B 5/16; F27B 2005/161

(57) ABSTRACT

Disclosed is a pumping system with reduced contamination. A vacuum pump system includes a mechanical vacuum pump mechanism within a hermetic pump that hermetically isolates the pump mechanism from ambient air. A pump inlet is hermetically sealed to the hermetic pump housing. A pump outlet is hermetically sealed at one end to the hermetic pump housing and at the other end to an inlet of a Peclet seal tube. The vacuum pump system produces a vacuum in a vacuum processing chamber. A sweep gas source injects a sweep gas into at least one of (i) the hermetic pump housing and (ii) the inlet of the Peclet seal tube. The sweep gas and a process gas flow through the Peclet seal tube to substantially isolate against the backflow of the ambient air through the Peclet seal tube.

### CROSS REFERENCE TO RELATED APPLICATION

This application is a non-provisional patent application claiming benefit to U.S. Provisional Patent Application No. 62/983,281 filed Feb. 28, 2020, the contents of which are herein incorporated by reference in their entirety.

### BACKGROUND

Various processing systems and laboratory instruments may require high purity and yet operate at medium or crude vacuum. This may be especially true in high temperature processes, such as metal processing and sintering, but is also true across a very wide range of systems and techniques outside of metal processing. Oftentimes high purity, such as parts per million (ppm) or parts per billion (ppb), may be desired, even in cases where vacuum levels are relatively modest and might be considered as “medium” or even “crude” vacuum for other industries, such as semiconductor fabrication. For example, it may be possible to sinter metal at 300 Torr of process gas, such as pure argon (which is considered crude vacuum), and yet exotic metals, such as certain titanium alloys, may require purity levels as low as 0.1 ppb in a mostly inert process gas.

Vacuum pumps, including mechanical pumps such as piston pumps, diaphragm pumps, scroll pumps, screw pumps, rotary vane pumps, and other displacement pumps, may be configured to evacuate a vacuum processing chamber to adequate medium or crude pressure, and yet may not be able to produce chamber atmospheres with extremely high purity (such as ppm or ppb) because they are subject to back-streaming of air, contaminants, and/or pump lubrication.

One conventional approach for achieving high purity with medium or crude vacuum may be to employ relatively expensive pumping systems, such as pumping systems that include multiple pumps staged in series and to purchase very expensive best-in-class pumps. In other conventional applications, high purity may be pursued in a brute force manner by providing excessive gas flow to at least somewhat suppress the back-streaming. Excessive gas flow may be, for example, a larger gas flow than would be necessary if the system exhibited better purity. In general brute force approaches result in crude compromises that can be costly to operate and still falls short of the truly desired purity level. Many such compromises are routinely employed and may provide an adequate compromise considered “good enough” in light of the high costs that may be associated with improving purity level further, and operators may merely accept the compromise on the grounds of lack of better options.

### SUMMARY

Disclosed are systems and methods for increasing purity in vacuum processing chambers through the use of what will be referred to as Peclet sealing. In most embodiments this involves tubing long in length relative to a cross-sectional area combined with an outflow through the tubing of a sweeping gas that prevents backflow of contaminants and ambient air through the tubing.

In an embodiment pumping system a hermetic pump housing is hermetically sealed to the ambient air. The pumping system is hermetically connected to and produces a vacuum in a vacuum processing chamber. The pumping system outputs to a Peclet seal tube. By injecting sweep gas that transits the Peclet seal tube the Peclet seal tube prevents backflow of contaminants and ambient air, providing isolation to the pumping system and allowing high purity levels in the vacuum processing chamber.

In an embodiment furnace system for debinding and sintering parts, a vacuum processing chamber has a pumping tube for outgassing process gas and contaminants. A pumping system produces a vacuum in the vacuum processing chamber. The pumping tube is heated during at least a debinding process to reduce condensation of contaminants within the pumping tube, including the debinding by-products outgassed during the debinding cycle, to a predetermined threshold. A process gas source is configured to inject a sweep gas into the vacuum processing chamber at least during the sintering cycle such that the pumping tube provides an amount of Peclet sealing during sintering. The pumping system employed may be the pumping system described above.

In another embodiment furnace system a dual pumping system is employed. A pumping tube from the vacuum processing chamber is used for out-gassing and is connected to a first and second valve. The pumping tube and valves are heated at least during a debinding process to prevent condensation of contaminants. The first valve is utilized during a debinding process to allow a first pumping system to produce a vacuum in the vacuum processing chamber. The second valve is utilized during a subsequent sintering process to allow a second vacuum to produce a vacuum in the vacuum processing chamber. The second vacuum system utilizes a Peclet seal tube and sweep gas to provide isolation during the sintering process. The first pumping system is isolated from the vacuum processing chamber during the sintering process. Therefore, the first pumping system may be a “dirty” pump contaminated by the debinding process without impacting the purity achieved during the sintering process.

Utilizing the above described systems and accompanying methods, remarkable purity may be achieved without the use of high cost pumps. Applicant has utilized these systems to sinter aluminum and other metals which have been historically difficult or impossible to sinter successfully.

Various other embodiments are disclosed in detail below.

### BRIEF DESCRIPTION OF THE DRAWINGS

FIGS. 1A-B depict prior art pumping systems.

FIG. 2 depicts a second prior art pumping system and manners of contamination.

FIGS. 3A-B depict a third prior art pumping system and manners of contamination.

FIG. 4 depicts a fourth prior art pumping system and manners of contamination.

FIG. 5 depicts a pumping system with contamination reducing sealing.

FIGS. 6A-C depict three embodiment pumping systems with reduced contamination.

FIG. 7 depicts a depiction of a Peclet seal tube.

FIG. 8 is a plot showing the relationship between Peclet number and normalized concentration.

FIG. 9 depicts another embodiment pumping system.

FIG. 10 depicts another embodiment pumping system.

FIG. 11 depicts a plot of temperature over time during a debinding process followed by a sintering process.

FIG. 12 depicts an embodiment furnace with a pumping system with reduced contamination.

FIG. 13 depicts another embodiment furnace with a pumping system with reduced contamination.

FIG. 14 depicts a furnace employing a double seal system in a closed state.

FIG. 15 depicts the furnace of FIG. 14 in an open state.

FIG. 16 depicts a perspective view of the dual seal system of FIGS. 14-15.

FIG. 17 depicts a plan view of the dual seal system of FIGS. 14-15.

FIG. 18 depicts a plan view of another dual seal system.

FIGS. 19A-H depict embodiment dual seal systems.

FIGS. 20A-D depict embodiment sealing in a tube furnace.

FIG. 21 depicts an embodiment system having a first stage pump in series with an embodiment pumping system.

FIG. 22 depicts an embodiment furnace wherein a retort has a Peclet seal tube for reducing contamination.

### DETAILED DESCRIPTION OF THE DRAWINGS

This disclosure can provide relatively low-cost systems and methods to achieve ppm or ppb, or even better than ppb purity without introducing expensive ultra-high vacuum pumps or stages and without excessive gas flow. At least some embodiments described herein may be configured to achieve parts per million (ppm), parts per billion (ppb), or even better than ppb sealing and outlet-inlet isolation from outside air at medium and/or crude vacuum with extremely robust and rugged pumps that cost less than conventional pumps. As used herein, “outlet-inlet isolation” may refer to isolation of air from the outlet of the pumping system and its inlet, and the term “sealing” may refer to more traditional sealing (such as gaskets and o-rings) between the inside and outside of our chamber, tubes, and pumping systems.

This disclosure may relate to vacuum chambers and pumps that operate at medium or crude vacuum and yet require sufficient sealing and outlet-inlet isolation for achieving high purity of ppm to ppb, or even better than ppb, at least relative to ingress and/or leakage of outside air.

For purposes of this disclosure medium vacuum may correspond to 3E-4 Torr and above, and may include even 759 Torr. In terms of art, definitions may vary depending on the field. For example, the term “crude vacuum” in one field may correspond to a hard vacuum in another field. For example, operators of Molecular-beam epitaxy (MBE) machines may consider 10E-6 Torr as crude vacuum while operators of sintering furnaces may consider 10E-6 Torr as deep or “hard” vacuum. In the present disclosure, hard vacuum may correspond to less than 1E-4 Torr, medium vacuum may correspond to 1E-4 to 100 Torr, and crude vacuum may correspond to 101 Torr to 759 Torr. (Note that atmospheric pressure is approximately 760 Torr).

Purity level may be characterized as “parts per N,” where parts is a number of molecules of contaminant in a pure gas, and N is a large number of pure gas molecules. For example, an otherwise pure sample of argon, at parts per billion ppb of oxygen would be contaminated by roughly one molecule of oxygen for every billion molecules of argon, and this certainly can be considered as highly pure for all but the most extreme applications. As was the case with regard to vacuum, terms of art related to atmospheric purity may vary by discipline. As described herein, high purity may correspond to 100 parts per million (ppm) or better (more pure). Medium purity may correspond to 100 ppm to 1 parts per thousand (ppt), and crude purity may correspond to purities that are worse (less pure) than parts per thousand (ppt).

Practitioners of many disparate disciplines, when utilizing vacuum, generally tend to rely on the same catalogs and vendors, which may focus on the most stringent vacuum requirements. For example, manufacturers of chambers, seals, pumps and vacuum gauges, (e.g., MDC Kurt Lesker, and Ideal Vac, among others) may tend to focus on similar products, which may be relatively costly and directed toward achieving hard vacuum at 10E-6 Torr or better. Achieving high purity with this technology may be relatively straightforward. Manufacturers and users of sintering furnaces may tend to rely on vacuum equipment made and sold for such high vacuum operation at least for the reason that this technology is well known and widely available.

Furthermore, vendors and sales personnel in the vacuum industry may be motived to encourage designers and users to rely on high vacuum equipment for lack of available alternatives. Accordingly, one seeking to achieve high purity will typically tend to employ commercially available standard high vacuum equipment.

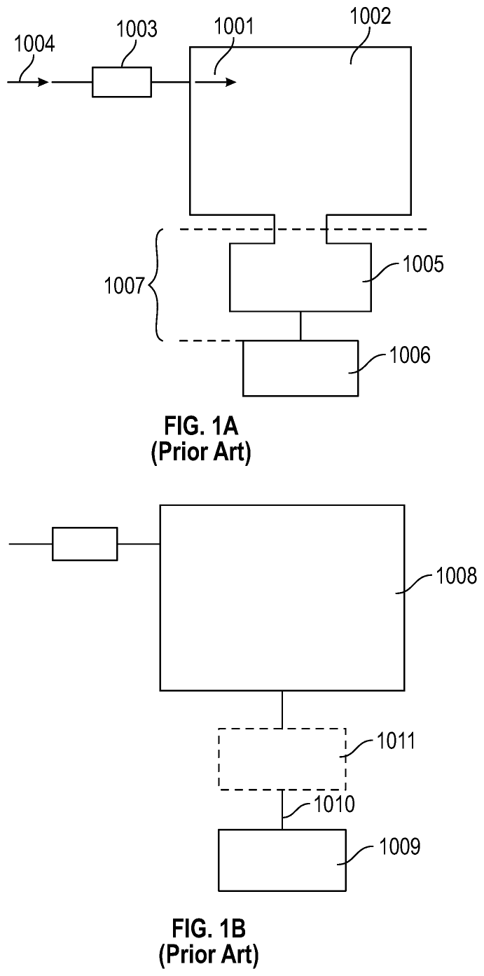

FIG. 1A is a schematic of an existing exemplary high vacuum system designed to use vacuum pumps for operation at high vacuum of less than 1E-4 Torr. Vacuum systems for materials processing may include process gas flow 1001 that can be injected into a high-vacuum processing chamber 1002 by way of a mass flow controller (MFC) 1003 that is fed by a supply of high purity process gas 1004. Such systems may require a multi-stage turbo-mechanical and/or thermo-mechanical pumping system as is represented in FIG. 1A. The system may comprise a vacuum processing chamber as a high vacuum chamber 1002 that is hermetically sealed to prevent air leakage from the outside, a mechanical high vacuum pump 1005, such as a turbo molecular pump, a thermo-mechanical diffusion pump, or a turbomolecular drag pump. Each of these high vacuum mechanical pumps may require a secondary “roughing” pump 1006 in series to pump on the outlet of the high vacuum pump. High outlet-inlet isolation 1007 may be achieved by the overall series pump arrangement.

Diffusion pumps may be described herein as “thermo-mechanical” because the mechanism for pumping gas molecules may include generating high velocity oil droplets colliding with gas molecules for mechanically encouraging gas flow in a manner analogous to the action of turbo-molecular pumps where it is the pump blades that are colliding with gas molecules. It is noted that non-mechanical high vacuum pumps, such as ion pumps and cryopumps, may be generally used only at very high vacuums of 1E-6 Torr or less, whereas diffusion pumps and turbo pumps may tend to be used with chambers that are at the higher pressure end of the “hard vacuum” range and may even be operated at medium vacuum pressures.

FIG. 1A illustrates an exemplary technique of using multi-stage pump systems comprising a high vacuum pump 1005 (for example, a thermo-mechanical or turbo-mechanical pump) pumping on a high-vacuum processing chamber 1002 in series with a medium vacuum “roughing” pump 1006, as a mechanism to achieve high vacuum, as well as high outlet-inlet isolation 1007. Vacuum sintering furnaces may include other components and/or features borrowed from vacuum systems, in particular pumps, valves, gauges and chambers in many cases.

FIG. 1B schematically illustrates a generic medium vacuum system, including a vacuum processing chamber 1008 and a roughing pump 1009 such as a mechanical pump, that is configured to receive process gas and is pumped with at least a mechanical vacuum pump. As described below, unlike some relatively expensive, best-in-class, mechanical pumps, relatively low cost “roughing” pumps may tend to allow a significant amount of air to backstream from the pump exhaust to the pump inlet. Also contaminants and/or vapor pump lubricant may backstream from inside the roughing pump 1009 to the pump inlet 1010. In some cases, this back-streaming may be somewhat mitigated by increasing process gas flow and by introducing various forms of traps 1011 (such as cryogenic and/or molecular sieve traps) or by adding multiple pumping stages in series. However, these mitigation strategies may be expensive and/or unsatisfactory or at least compromising in nature. Even when the medium vacuum chamber is hermetically sealed to state of the art levels (e.g., similar to levels that may be used in ultra-high vacuum systems) it may be common for the purity of the process atmosphere to be limited by the back-streaming and the limitations of the mitigation techniques. It may also be common for users and designers to resolve this problem by employing expensive pumping systems that have high initial costs as well as high operating costs. For example, it may be common for users to employ a roots blower pump in series with a best-in-class rotary vane pump. However, even in this configuration, it may be necessary to include cryogenic inlet traps (such as liquid nitrogen traps) to diminish back-streaming of pump oil into the chamber.

FIG. 2 is a schematic representation of mechanisms of back-streaming in typical high, medium, and low-cost roughing pumps, such as a piston pump, diaphragm pump, rotary vane pump, or other displacement pump. As mentioned previously, regardless of cost, each of these pumps may exhibit significant back-streaming 2001 of outside air from the exhaust of the pump to the pump inlet and may not be capable of providing ppm of isolation, let alone ppb of isolation at the pump inlet. Purity at the inlet can be further degraded by housing leakage and or diffusion of air 2002 through the pump housing itself including leakage through shaft seals and imperfect gaskets. Pumps that may be capable of achieving ppm of isolation against air may tend to use oil, which may introduce back-streaming of contaminants and/or lubricants 2003 from within the pump, as is illustrated in FIG. 2. For example, even best-in-class rotary vane pumps may exhibit back-streaming of oil and other and other hydrocarbon contaminants to an extent that that it may be challenging to achieve sufficient purity with respect to oil and hydrocarbons and various traps including cryo-traps are often used to at least somewhat mitigate oil mist. In such cases, a modest amount of process gas flow (for example 1 slm) and a relatively long and thin pumping tube between the medium vacuum processing chamber and the pump (for example a ½″ diameter tube 1 m in length) may facilitate better purity in the chamber as compared to the inlet of the pump. However, these approaches may lead to comprised performance, such as higher pressure than is desired, or very high cost, as larger pumps may be required to achieve desired pressure with the larger gas flow. In other words, the “brute force” use of higher gas flow may also increase cost with respect to equipment as well as operation. Also, as mentioned previously, cryogenic inlet traps and other traps may be used, but these approaches add to cost and complexity as well as other compromises.

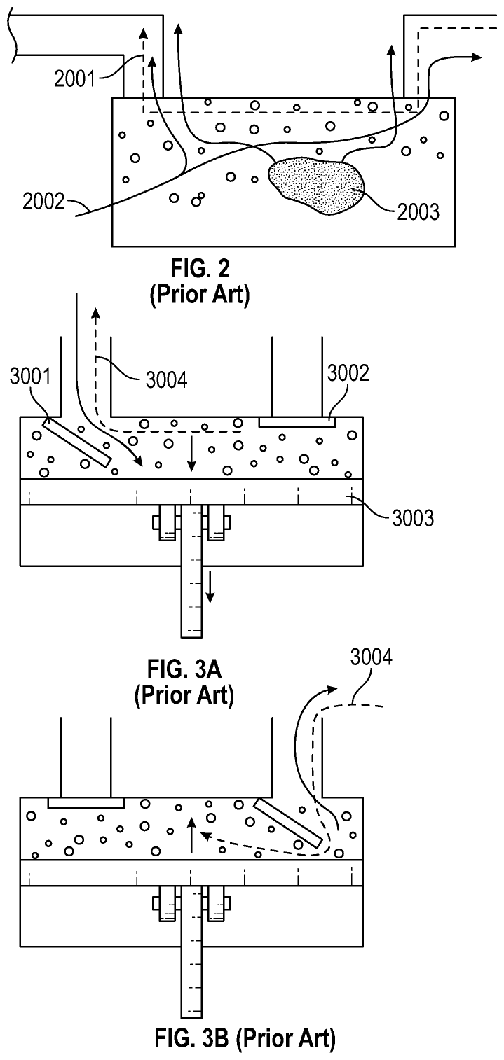

FIGS. 3A and 3B illustrate the basic pumping mechanism for piston pumps having inlet and outlet valves (allowing for inlet flow and outlet flow respectively) and a reciprocating piston. Piston pumps are described herein for explanatory purposes, and it is to be understood that the issues described may also apply to other types of displacement pumps. During at least a portion of the inlet stroke (FIG. 3A), the inlet valve 3001 may be open and the outlet valve 3002 may be closed for most (or all) of the intake stroke, such that the piston 3003 displaces volume from the inlet into the piston as is shown in FIG. 3A. As can be seen in FIG. 3A, some backflow from the pump housing into the pump inlet will normally occur. During the outlet stroke, the inlet valve 3001 may be closed and the outlet valve 3002 may be open for most (or all) of the outlet stroke, such that the content of the piston is displaced to the outside. As can be seen in FIG. 3B, some backflow 3004 from the ambient air into the pump housing will normally occur.

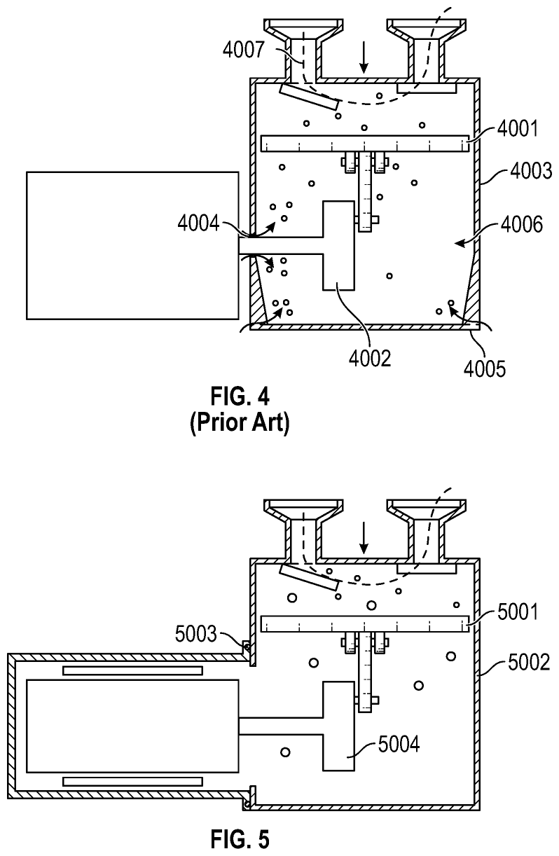

As is noted in FIG. 4, various imperfections such as imperfect seals, leaks, and imperfect geometric fits and tolerances may each contribute to the presence of some degree of back-streaming, even in relatively expensive best-in-class pumps. This back-streaming may diminish outlet-inlet isolation of the pump. Housing leaks gasket leaks, and shaft seal leaks may also contribute to the base pressure of a given pump. Furthermore, displacement pumps may include some finite degree of excess inactive or “dead” volume in the piston chamber that cannot be purged with each outlet stroke, and this dead volume may uptake a significant amount of residual air molecules from the outside air and may contribute to limiting base pressure and back-streaming. The tendency for back-streaming may be causally correlated to a quantifiable performance specification known as “base pressure”. The base pressure of a given pump may be defined as the measured inlet pressure (pressure at the inlet) when the pump inlet is sealed off during operation, and, in many cases, the base pressure is limited by back-streaming, such that a relatively lower cost lower precision pump may tend to exhibit more back-streaming and therefore tend to achieve poorer (higher) base pressure. For example, a best-in-class rotary vane, piston, or diaphragm pump (examples of which may be produced by Edwards, Varian, or Kinney) may cost several thousand dollars and exhibit a base pressure of 0.001 Torr of air from the outside, whereas a relatively low cost piston pump or diaphragm pump used in pneumatic applications may exhibit a base pressure of 0.001 Torr to 1 Torr, 1-10 Torr, 10-100 Tor, 100-300 Torr and 300-750 Torr, of air from the outside. Base pressure at the inlet may develop by back-streaming, which may be significantly larger in low cost pumps, such that base pressure of air may constitute a limit to outlet-inlet isolation of the pump.

As illustrated in FIG. 4, the piston 4001 and the drive mechanism 4002 may be contained in a sealed pump housing 4003 having leaks, including a relatively leaky shaft seal 4004 (where the motor shaft enters the housing), gasket leaks at static seals 4005 (such as adhesively glued face seals or gaskets where two separate portions of pump housing are sealed to one another), and housing leaks 4006 through porous housing material, such as plastic and/or cast metal. Some or all of these leaks may be considered tolerable especially insofar as the total of all those leaks introduces similar or smaller amount of air than is introduced through back-streaming 4007.

Applicants further recognize that, in the interest of cost of the pump, for low cost and/or moderate performance pumps it may be unnecessary to provide truly hermetic shaft seals, static seals, and/or impermeable materials configured to block air significantly better than the pump itself. Said differently, base pressure due to back-streaming may constitute a meaningful limitation, such that, from a cost perspective, it may be unnecessary to provide pump housing and shaft seals that produce leaks significantly smaller than that of the back-streaming.

Moreover, it may be unnecessary to include pump seals that are capable of sealing to a degree in excess of the outlet-inlet isolation developed by a given pumping mechanism. For example, if a relatively low cost permeable housing formed of cast aluminum may be suitable, and it may therefore be unnecessary to use somewhat more expensive housings, such as machined aluminum, if, for example the pump itself is configured to provide a base pressure of 0.01 Torr of outside air as the base pressure of the pump. It is noted that for a non-hermetic pump, residual air molecules may be introduced from either the pump outlet or through the various housing leaks. Again, while FIGS. 3 and 4 depict piston pumps, it should be understood that these figures are included to clarify various principles that tend to at least generally apply to other types of displacement pumps.

FIG. 5 illustrates a pump 5001 having a hermetically sealed pump housing 5002 composed of an impermeable housing material such as non-porous steal or aluminum and hermetic static seals 5003 such as an o-ring, and an exemplary drive mechanism 5004 (for converting rotary motion of a motor to linear motion of the piston) having no shaft seal and thus no resulting shaft seal leak. For purposes of this disclosure when we refer to a hermetically sealed pump housing it should be understood that any leakage through the housing is at least one order of magnitude lower than outlet-inlet back streaming exhibited by that pump. Applicant routinely produces hermetically sealed pumps that exhibit 3 to 6 orders of magnitude less leakage (through housing, shaft, and static seals) as compared to the outlet-inlet back-streaming.

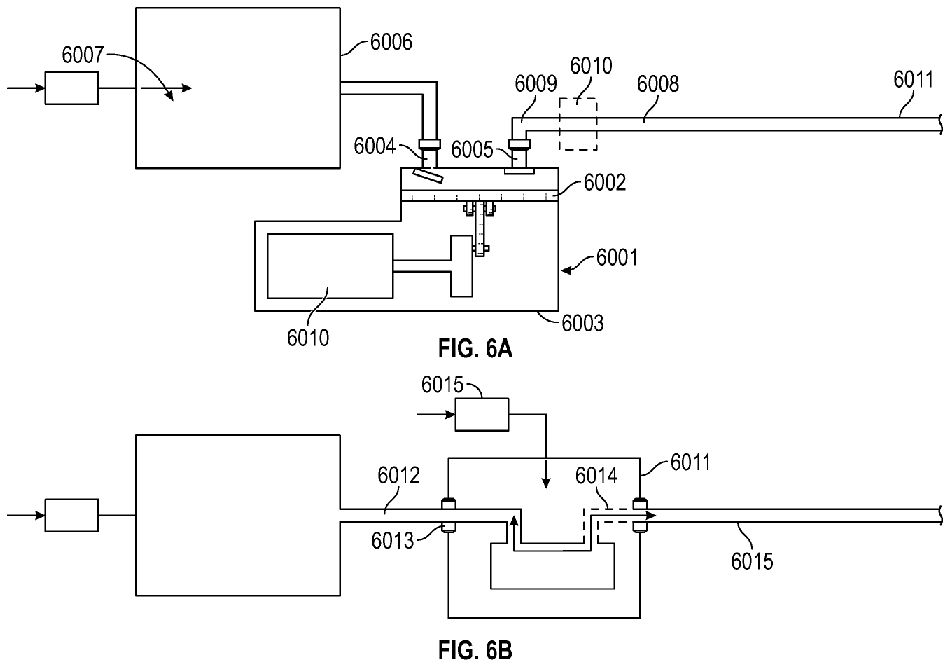

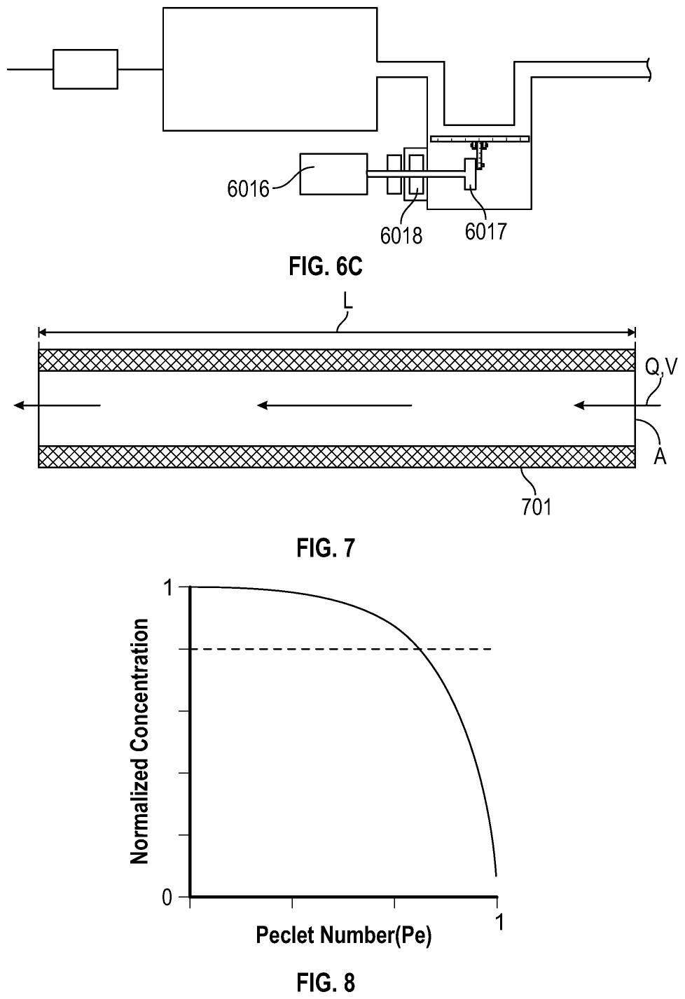

FIG. 6A shows a pumping system 6001 that may utilize a mechanical vacuum pump mechanism 6002 within a hermetic pump housing 6003 that hermetically isolates the mechanical vacuum pump mechanism to achieve sufficient sealing and overall system outlet-inlet isolation of ppm, ppb, or better vacuum processing chamber purity with a relatively low cost pump including a low cost pump mechanism that operates with high back-streaming and thus exhibits relatively poor base pressure (PB), for example in the range of 0.001 Torr to 1 Torr, 1-10 Torr, 10-100 Tor, 100-300 Torr and 300-750 Torr. FIG. 6A shows a piston style pump mechanism of the sort illustrated in FIG. 5 having a hermetic pump housing 6003 with impermeable housing walls and hermitic pump housing seals at any joints in the housing to hermetically isolate the mechanical vacuum pump mechanism 6002 from outside ambient air. In this embodiment, the motor 6010 may be contained within the hermetic pump housing in part in order to avoid using a potentially leaky shaft seal. A pump inlet 6004 is hermetically sealed to the hermetic pump housing 6003 and serves as an inlet path to the vacuum pump mechanism 6002. A pump outlet 6005 is hermetically sealed to the hermetic pump housing 6003 and serves as an outlet path from the mechanical vacuum pump mechanism 6002. The vacuum pump system 6001 produces a vacuum in vacuum processing chamber 6006. A process gas 6007 may be injected into the vacuum processing chamber. A Peclet seal tube 6008 has a Peclet seal tube inlet 6009 hermetically sealed to the pump outlet 6005. By operation of the pumping system 6001 the process gas flows from the inlet of the Peclet seal tube towards an outlet 6011 of the Peclet seal tube 6008 to substantially isolate against the backflow of the ambient air through the Peclet seal tube 6008. The Peclet seal tube 6008 may optionally include a ballast volume 6010 arranged in gaseous communication with the inlet 6009 of the Peclet seal tube such that the ballast volume can reduce pressure fluctuations caused by pump pressure ripple. The mechanical vacuum pump mechanism 6002 may be a displacement pump. Examples of suitable displacement pumps include, without limitation, piston pumps, a diaphragm pumps and scroll pumps. The Peclet seal tube 6008 is preferably constructed from a material that resists condensation of contaminants. In certain embodiments, the Peclet seal tube is constructed from metal.

The pumping system of FIG. 6A that may provide sufficient sealing and sufficient outlet-inlet isolation to achieve ppm or even ppb chamber purity (relative to outside air) with a relatively low cost pump, for example a pump that exhibits relatively poor base pressure (PB) for example in the range PB=0.01 Torr to 300 Torr. The thin Peclet seal tube may be, for example, a ⅛″ diameter (e.g., ⅛″ inner diameter)×0.5 meters to several meters long metal tube. As there may be sufficient process gas flow to produce laminar flow within the Peclet seal tube, and as the Peclet seal tube may be sufficiently long and sufficiently thin, there may be no theoretical limit to the degree of Peclet isolation that can be achieved relative to the outside air at the outlet of the Peclet seal tube. (However there may be practical limitations and considerations, including off-gassing of contaminants from the inner walls of the Peclet seal tube and considerations with regards to Peclet seal design and performance described below.) While the Peclet seal tube may not form a “seal” in the traditional sense, the tube may nevertheless be referred as a Peclet “seal” tube to emphasize the relatively high degree of outlet-inlet isolation, for example of outside air, that may be achieved between the outlet and the inlet of the tube. While the Peclet seal tube may provide ppm, ppb, or even better than ppb isolation, it may be considered reasonable to describe it as a “seal” in the sense that it inhibits flow and/or diffusion of air from the outlet from reaching the inlet. For any pure gas flow rate greater than 0.05 slm it may be straightforward to achieve ppm and ppb isolation of the Peclet tube inlet relative to the Peclet tube outlet. For process flow rates between less than 0.05 through the chamber and into the pump inlet it may be more challenging but may nevertheless be achieved through techniques described herein.

This overall system and method may provide advantages for achieving relatively high purity at relatively low cost, and this may be achieved in part because this method and system at least generally decouple the issue of base pressure and purity in the sense that the pump is no longer required to do all the work of achieving both vacuum and isolation as tends to be the case in traditional pumping systems where the pump system is generally relied on for both vacuum isolation between input and output Unlike conventional systems that primarily rely on pumps to achieve high isolation (often characterized in terms of vacuum art as compression ratio), the systems and methods described herein may include a Peclet seal tube for establishing isolation between the outlet and the inlet of the pumping system, while the pump may be relied upon mainly to produce the desired vacuum, such that any additional outlet-inlet isolation against backflow achieved by the pump is considered beneficial but not necessarily required. Again, with regard to air at the outlet of the Peclet seal tube, the pump may provide for vacuum even if the pump does not exhibit impressive isolation against back-streaming, and the tube may provide much, or most, of the sealing and outlet-inlet isolation. It should be understood that even for a relatively low-cost low performance pump mechanism, the sealing of the pump housing may be hermetic, especially with regard to the embodiment illustrated in FIG. 6A. However, sealing of the pump housing need not be highly costly, even in cases where a very high degree of hermiticity is necessary. In general, static sealing may be relatively straightforward and cost effective if designed and executed properly in accordance with well-known vacuum sealing techniques. Relaxing specifications with regard to base pressure and compression ratio on the internal displacement pumping mechanism may allow for a relatively low cost and/or robust pumping mechanism configured to provide the vacuum pressure needed while the Peclet tube provides for high purity.

FIG. 6B illustrates an exemplary embodiment that may facilitate the use of an unmodified non-hermetic pump that does not require hermetic sealing of the pump body. In this embodiment, the pump may be contained in an external hermetic pump housing 6011 that is configured as a container with hermetic tube feedthroughs at the inlet and outlet of the hermetic pump housing. In this embodiment, there may be a pumping tube 6012 hermetically sealed to the pump inlet 6013 and similar pump outlet 6014 is optionally included. This pump outlet 6014 may prevent contamination of the hermetic pump housing but in the absence of contamination, the system may function as intended without this tube. For example, the pump may exhaust into the container, and the Peclet seal tube 6015 may continue to provide outlet-inlet isolation just as it would with the pump outlet hermetically sealed to an inlet of the Peclet seal tube. A sweep gas source 6015 injects an amount of sweep gas into the hermetic pump housing, which provides sweep gas flow through the Peclet seal tube similarly to the process gas of FIG. 6A. As was the case in the embodiment of FIG. 6A the embodiment of FIG. 6B may allow for the use of a relatively low cost pump to provide the vacuum pressure needed, while the Peclet tube 6015 may provide for ultra-high purity. To further clarify, ppm purity at the pump inlet may be achieved by operating in accordance with FIG. 6B with a relatively low cost piston pump or diaphragm pump (e.g., a KNF or Welch brand diaphragm pump) having a relatively leaky plastic and rubber diaphragm that would normally be used in low cost low performance pneumatic applications and would normally be incapable of providing even parts per thousand (ppt) of outlet-inlet isolation. In this case, the pump used by itself might not be capable of providing for anything better than parts per hundred or perhaps even one part in ten.

FIG. 6C depicts a further embodiment in which a motor 6016 outside the hermetic pump housing drives the mechanical vacuum pump mechanism 6017 via a hermetic rotary coupler 6018. In certain embodiments, the hermetic rotary coupler is a magnetic rotary coupler.

For purposes of descriptive clarity, it can be useful to again clarify two distinct mechanisms by which displacement pumps provide for sealing and isolation. In one mechanism, the hermetic pump housing may provide sealing between the inside of the pump and the air outside the pump. This sealing may be thought of as housing sealing and for a pump with a hermetically sealed housing, the housing sealing integrity may be very high integrity, for example a hermetic pump housing may provide for a leak rate through the housing in the range of 1E-6 Torr-liters per second (TL/S) to less than 1E-9 TL/S. Another form of isolation can be described as the pump's outlet-inlet isolation between the outlet of the pump and the inlet and in general a pump with lower back-streaming may provide for better isolation in this regard. Isolation may correspond to a pump's “compression ratio,” and, in many cases, compression ratio and base pressure may be derived from one another. For example, a pump having a compression ratio of 1E6 may be exhausted to air and the base pressure would be roughly 0.001 Torr. Mechanical pumps with state-of-the-art low base pressure may also provide for high state-of-the-art outlet-inlet isolation which in many cases goes hand in hand with state-of-the-art high compression ratio. Compression ratios, such as a compression ratio of 1E6, may be readily attained in expensive best-in-class displacement pumps. By contrast, low-cost pumps, such as diaphragm pumps, or low-end dry piston pumps, may only achieve compression ratios of 10, 100, 1000, or 10,000, and the cost of a given pump may tend to drop with lower compression ratio.

In at least some aspects of this disclosure, a relatively low cost pump having a hermetic pump housing and a relatively modest base pressure of 0.01 Torr to 100 Torr may be hermetically sealed at the pump outlet to a Peclet seal tube such that the pumping system and the Peclet seal tube cooperate to provide for isolation of ppm to 0.1 ppb at the inlet of the pump relative to outside air.

In at least some aspects of this disclosure, based on FIG. 6A and/or FIG. 6B, systems with at least 0.1 slm of gas flow, 1 ppm pump inlet purity (relative to outside air) may be attained with a low cost pump that has a compression ratio of 10 sealed to a Peclet seal tube with Peclet isolation of 10 ppm relative to outside air. The pumping system may be configured to contribute roughly a factor of 10 additional outlet-inlet isolation in addition to that of the Peclet tube seal.

In at least some aspects of this disclosure, based on FIG. 6A and/or FIG. 6B, with at least 0.1 slm of gas flow, 1 ppm pump inlet purity can be attained with a low cost pump that has a compression ratio of 100 sealed to a hermetic Peclet tube with Peclet isolation of 100 ppm relative to outside air. The pump may be configured to contribute roughly a factor of 100 additional outlet-inlet isolation in addition to that of the Peclet tube seal.

In at least some aspects of this disclosure, based on FIG. 6A and/or FIG. 6B, with at least 0.1 slm of gas flow, 1 ppm pump inlet purity may be attained with a low cost pump that has a compression ratio of 1,000 hermetically sealed to a Peclet seal tube with Peclet isolation of 1,000 ppm relative to outside air. The pump may be configured to contribute roughly a factor of 1,000 additional outlet-inlet isolation in addition to that of the Peclet tube seal. While exemplary embodiments (using a pump with 0.001 Torr base pressure) is described for completeness, it may be unnecessary, and perhaps even excessive, to use pumps with compression ratio of 1,000. Indeed, as described below, there may even be disadvantages to using pumps with an excessively high compression ratio (and low base pressure) at least for the reason that such pumps can be sensitive to contaminants and more difficult to decontaminate as compared to lower cost designs that are better suited to the approach described herein. Accordingly, it may be preferable to use pumps that have sufficiently high compression and sufficiently low base pressure to provide the desired vacuum, and not a significantly stronger vacuum.

In at least some aspects of this disclosure, based on FIG. 6A and/or FIG. 6B, with at least 0.1 slm of process gas flow (for example pure argon), 1 ppb pump inlet purity (relative to outside air) may be attained with a low cost pump that has a compression ratio of 10 hermetically sealed to a Peclet seal tube with Peclet isolation of 10 ppb relative to outside air. The pumping system may be configured to contribute roughly a factor of 10 additional outlet-inlet isolation in addition to that of the Peclet seal tube.

In at least some aspects of this disclosure, based on FIG. 6A and/or FIG. 6B, with at least 0.1 slm of gas flow, 1 ppb pump inlet purity may be attained with a low cost pump that has a compression ratio of 100 hermetically sealed to a Peclet seal tube with Peclet isolation of 100 ppb relative to outside air. The pumping system may be configured to contribute roughly a factor of 100 additional outlet-inlet isolation in addition to that of the Peclet tube seal.

In at least some aspects of this disclosure, based on FIG. 6A and/or FIG. 6B, with at least 0.1 slm of gas flow, 1 ppb pump inlet purity may be attained with a low cost pump that has a compression ratio of 1,000 hermetically sealed to a Peclet seal tube with Peclet isolation of 1,000 ppb relative to outside air. The pumping system may be configured to contribute roughly a factor of 1,000 additional outlet-inlet isolation in addition to that of the Peclet tube seal.

The outlet-inlet isolation may be quantified as a unitless ratio of the amount of air from the outside at the inlet of the pump divided by the amount of air outside the pump and at the outlet of the pump.

In general applicants recognize that commercially available mechanical vacuum pumps (i.e. roughing pumps) are not intended to provide impressive isolation against outside air. For example dry pumps such as piston pumps, scroll pumps and diaphragm pumps only exhibit a compression ratio insofar as they reduce pressure but they do not provide for any degree of isolation in the absence of process gas flow since the entire base pressure under no-flow conditions consists of air from the outside. In one exception, it may be possible to obtain wet rotary vane pumps that use pump oil as a sealant. However, such pumps may tend to introduce hydrocarbon gases. Moreover, oil pumps low in contaminants may be relatively expensive with cleanliness that is short-lived when exposed to contaminants.

Applicants further recognize that in traditional vacuum systems, a high performance vacuum pump such as a turbo molecular pump having high compression ratio (>1E\hat{ }) may be relied upon to provide vacuum pressure and to provide for isolation between the inlet of the pump and the air outside the pump and/or at the exhaust of the pump. However, in exemplary approaches described herein, the function of the pump and the Peclet tube seal may be allocated such that (i) the pumping system may be relied upon for providing vacuum pressure at the inlet of the pump while providing for little if any contribution to isolation, and (ii) the Peclet seal tube may not produce no contribution to the vacuum but may provide for the majority of isolation between the pump inlet and the ambient air outside the pump and/or at the outlet of the Peclet seal tube.

As described above, the Peclet tubes were described only insofar as necessary for purposes of including Peclet tubes in a pumping system. It is noted that Peclet seals may allow for numerous dimensional variations, and it is practical considerations and features that tend to determine actual practical performance. This section discusses basic principles of operation as well as details of Peclet tube seals with respect to design and practical implementation Exemplary equations for designing a Peclet tube seal as illustrated in FIG. 7 are as follows.

### Definitions

L=length of Peclet tube (m)
A=cross sectional area of tube (m²)
V=average flow velocity of the sweep gas in the tube (m/s)
D=Diffusivity s(m²/s)
Pe=dimensionless Peclet number
I=Isolation (unitless)
Q=volumetric flow rate of sweep gas through the tube (m\hat{ }3/s)
Where diffusivity may be the diffusivity of one gas in another at a given temperature and pressure. For example, at room temperature and atmospheric pressure, the diffusivity of oxygen in argon is approximately D(O−Ar)=0.3 cm\hat{ }2/s=3E-5 m\hat{ }2/s. More elaborate calculations can be performed if tracking multiple species. Furthermore a person skilled in the art having access to literature on diffusivity can readily account for various levels of complexity including accounting for temperature effects, pressure dependence and non-linear effects such as turbulence. For example one of many potentially useful references in the literature are R. B. Bird, W. E. Stewart, and E. N. Lightfoot, Transport Phenomena, 2nd ed., New York: John Wiley & Sons, 2002.
The dimensionless Peclet constant may be a dimensionless ratio

Pe=V*L/D Eqn 1.

This Peclet number may be useful to the extent that the larger the Peclet number, the better the sealing in accordance with the following equation

I=exp(−Pe) Eqn 2.

It is noted that equation 1 may be rewritten to include flow rate:

Pe=Q*L/(A*D) Eqn 3.

Having these equations and concepts as disclosed herein, a person of ordinary skill in the art may be able to use these insights to generate numerous embodiments and examples of Peclet tube seals and will appreciate that this one-dimensional model and approximation reveals Peclet tube sealing to be an effective technique, such that it may be possible to generate highly varied solutions with massive theoretical margin. For example, even given a very small process and/or sweep gas gas flow of 0.1 slm of argon (0.1 m\hat{ }3/s at stp), a tube of 3 mm diameter and length approximately 6 mm may, according to equations 1 and 2, provide for isolation between inlet and outlet of 1-2E-31 which is twenty orders of magnitude better than 0.01 ppb. FIG. 8 illustrates a curve calculable based upon the above equations that represents the normalized ration of concentration in a log-log plot at the inlet relative to the outlet of a Peclet seal tube for a given Peclet number at the inlet relative to the outlet of a tube for a given Peclet number.

It is to be understood here and throughout the application that process gas may be useful as contributing to a particular process as well as contributing to the sweep gas flow. PecletSweep gas may be injected the hermetic pump housing or at the inlet of the Peclet seal tube. Alternatively, a process gas may be serve as a sweep gas when injected into the vacuum processing chamber.

It is noted that the above analyses is applicable to flow paths having many different cross sectional shapes. For example the above concepts and equations apply to planar flow of fluid in a gap defined by parallel plates having a gap height G and width W defining a cross sectional area G*W. For a flow path of length L the cross sectional gap area can be used in equation 1 with V=Q/(G*W). It is further noted that the equations apply very well at vacuum pressure insofar as the flow remains laminar. However the diffusivity D is pressure dependent in approximate inverse proportion to pressure. So for vacuum pressure Pvac in units of Torr it can be estimated that D increases according to D(O—Ar)˜(760/Pvac)*0.2 cm\hat{ }2.

Applicants recognize that the above equations correspond to a relatively simple one-dimensional model. However, this model may generally correspond to physical pump systems configured to achieve ppb, and better, isolation using even relatively short and relatively large diameter tubes. Moreover, for reasonable tube designs, it may be desirable to evaluate various practical considerations beyond the theoretical design of the Peclet tube seal. Such practical considerations may tend to dominate performance limitations and can include consideration of off gassing of contaminants from inside the walls of the Peclet seal tube and also may include leaks through various seals such as O-rings and or metal gasket seals for example sealing a pump outlet to a Peclet tube inlet. In order to achieve ppm and ppb purity in a low cost and practical manner, it may be advantageous to be mindful of various considerations described below.

One exemplary approach is to use tubes that are one or two meters long and set the diameter of the tube such that the tube does not limit or otherwise choke the displacement velocity of the pump and/or the sweep gas. Thus, it may be desirable to make the tube as small as possible without significantly affecting the pump. By following this approach, tubes having 2 mm to 10 mm inner diameter for process gas flows between 0.1 slm and 10 slm, respectively, may be suitable. In such cases, predictions based on the above one-dimensional model may result in performance many orders of magnitude greater than necessary. For example, a tube of about one, two, or three meters in length, ranging from ⅛″ to 0.59″ (1.5 cm) diameter may be readily practical and not excessively restrictive. Indeed, the theoretical designs of tubes according to this disclosure may not be noticeably restrictive on pumping action and may tend to provide theoretical Peclet isolation at least ten orders of magnitude better than is required. In such cases, other practical aspects will tend to determine the system performance limits.

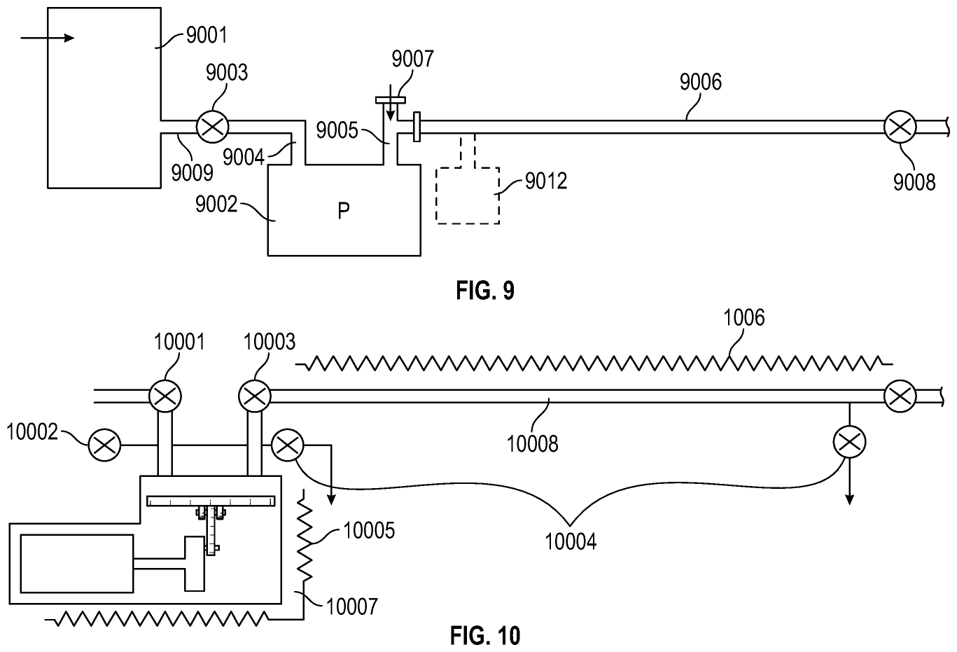

Based on the foregoing approach, practical aspects and/or considerations of significance may include the following, which are shown schematically in FIG. 8 and FIG. 9.
(1) Use of impermeable tubes such as metal tubes.
(2) Use of tubes that may be easily cleaned and/or replaced, such as stainless steel tubing, and replacing and/or cleaning the tube when it becomes contaminated. In some cases, this may include cleaning and re-installing the tube with every run (every sintering cycle, for example). In some cases, cleaning the tube may be done in situ by flushing solvent through the tube. Note that the pump may also be similarly cleaned in situ, if desired.
   a. FIG. 10 illustrates relatively cleaner inlet 10004 and cleaner outlet valves 10005 that may be suitable for flushing cleaner through the pump and or the Peclet tube seal. In various embodiments, the pump inlet valve and the Peclet tube outlet valve may remain closed while cleaning solvent is flushed through the pump and or Peclet tube.
(3) Use of hermetic tube fitting at the hermetic pump housing and the Peclet seal tube outlet and any other part of the hermetic envelope of the system.
   a. Swagelok fittings.
   b. O-rings and KF or ASA flanges.
   c. Copper gasket seals with conflat flanges.
(4) Keeping the inside of the Peclet seal tube sealably isolated from the outside, even between operating cycles when the chamber is not in service. (as described below)
   a. This may be achieved by including a hermetically sealed valve at the outlet of the tube.
   b. This may also be achieved by continuously running pure inert sweep gas through the Peclet seal tube when the system is not in use.
(5) Maintaining a smooth laminar flow for at least a portion of the tube to compensate for pulsating action of pump.
   a. This may be achieved with a ballast volume at the inlet of the tube which is shown as an option in FIG. 9 as ballast volume 9009.
   b. This may be achieved by making the tube longer, such that the tube itself smooths pressure variation as the gas flows along its length. Lengthening the tube may not be necessary (e.g., in at least some applications, a length of one meter may be more than ten or even a hundred times the theoretically desired length). (If longer lengths are desired the tube may be coiled to avoid taking up excessive space.)
   c. Immediately preceding techniques, for example, a and b, may be combined.

For metal and hermetically sealed tubes, such as stainless steel tubes, and Swagelok fittings a predominant practical issue may be contamination and off-gassing of the Peclet seal tube itself, particularly in the section closest to the pump. It may take hours, or even days, for moisture and other contaminants to be flushed out by Argon, a process that may be accelerated using a low cost heater, such as nichrome wire heaters, to “bake off” contaminants. The use of a hermetically sealed valve may be successful at maintaining cleanliness between runs.

It may be desirable to provide high hermiticity of the connections and the Peclet tube seal (for example, Helium leak rates less than 1E-10 Torr Liters per Second TL/S) and thus, the need to replace tubes frequently, even as often as every run, may not be burdensome in most applications.

FIG. 9 depicts another embodiment pumping system. A vacuum processing system is connected to a vacuum pump system via a pumping tube 9009 which is separated from the pump inlet 9004 via a valve 9003. Pump outlet 9005 is hermetically sealed to Peclet seal tube 9006. A sweep gas source 9007 is configured to inject sweep gas into the Peclet seal tube 9006 such that the sweep gas flows through the Peclet seal tube from an inlet 9010 of the Peclet seal tube 9006 towards an outlet 9011 of the Peclet seal tube 9006 to substantially isolate against the backflow of the ambient air through the Peclet seal tube. A ballast 9012 as previously described may be employed. A valve 9008 placed at the outlet 9011 of the Peclet seal tube may be used to seal the Peclet seal tube from the ambient air as described above when sweep gas is not being injected.

Injecting gas at the inlet of the Peclet seal tube, as shown in FIG. 9, may allow the systems and methods of this disclosure to be executed even in medium vacuum systems having little or no process gas flow. Furthermore, contributions to sweep gas in the Peclet seal tube can addition be provided by from process gas and/or sweep gas injected into the pump housing. As mentioned previously, the systems and methods described herein may achieve relatively high purity without the use of relatively costly high purity pumps. These systems and methods may allow for the use of a pumping mechanism that is sufficient to provide the desired vacuum, but not necessarily capable of providing the needed isolation. Thus, the role of the pump may be largely reduced to just maintaining vacuum. In the case of FIG. 9, the job of the pump may not be diminished by the injection of gas after the pump, as long as the pressure at the point of injection is only slightly above atmospheric pressure, which may be relatively easily achieved due to the robustness of the Peclet sealing mechanism.

The systems and methods described herein may offer additional advantages in comparison to the use of serial stages and/or multiple pumps connected in series. As described above, pumps themselves may tend to limit purity as contamination builds up inside the pumping mechanisms. In many cases, stacking pumps in series can do little or nothing to overcome contamination within the pump that is directly connected to the chamber. Furthermore, best-in class-pumps may tend to be relatively sensitive to contamination and in fact may be difficult to clean. In contrast, the requirements on pumps described herein may be relatively minimal (e.g., orders of magnitude lower than the requirement in conventional approaches). Accordingly, pump systems described herein may incorporate pumps that are relatively simpler and less prone to contamination and that can be easily cleaned, or even self-cleaned, in situ. For example, for a system than runs at 10 Torr, it may be possible to employ a relatively simple Teflon coated oil free piston pump that is relatively small in size and that can be self-cleaned by circulating alcohol through the pump, as is depicted in FIG. 10.

FIG. 10 depicts another embodiment pumping system in many ways similar to FIG. 6A and the disclosure relating to FIG. 6A will be generally applicable to FIG. 10. Valve 10001 controls flow from a vacuum processing chamber (not shown) into a hermetic pump housing 10007. Valve 10003 controls flow from the hermetic pump housing 10007 to the Peclet seal tube 10008. Pump cleaning heaters 10005 and tube cleaning heaters 10006 can be activated both during and between runs to drive out moisture and other contaminants. The relaxation of performance specifications (e.g., relaxation of base pressure and/or compression ratio requirements) may increase and enhance freedom to design and/or obtain pumps that tend to remain clean and/or can be easily cleaned in situ. For example, suitable pump designs may be operated at 50 C-100 C, 100 C-200 C, 200 C to 300 C and even greater than 300 C, and these otherwise challenging pump designs may be achievable at least in part due to the relaxed specifications on base pressure, which may allow for large gaps and loose mechanical tolerances that would be incompatible with typical high performance high compression pumps. Techniques, such as in situ solvent flush and/or in situ heating, may tend to be less practicable in high performance displacement pumps, such as rotary vane pumps, scroll pumps, and roots blowers.

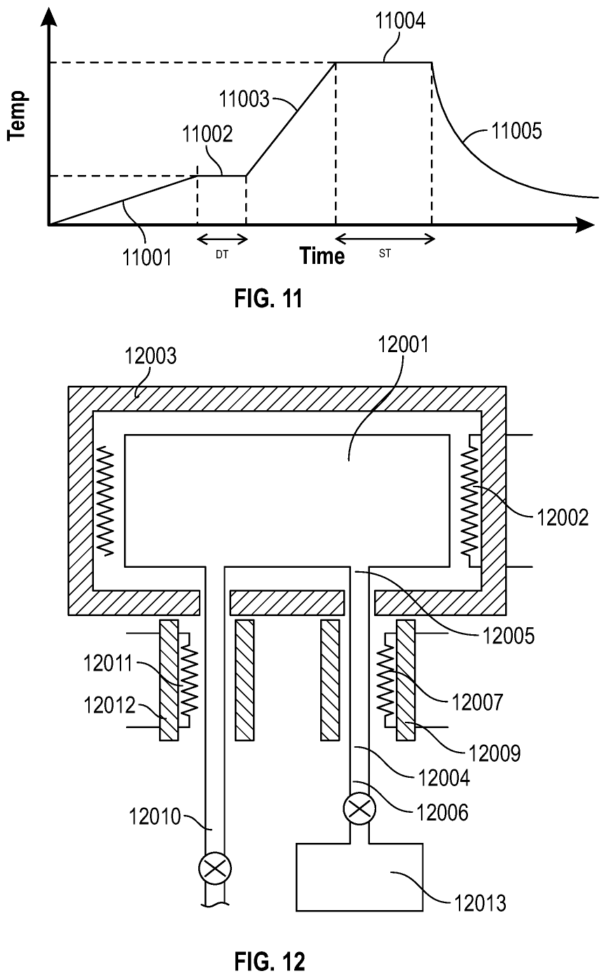

FIG. 11 illustrates a plot of processing chamber temperature (vertical axis) vs. time (horizontal axis) for the hot zone in a vacuum processing chamber of a typical two stage debinding and vacuum sintering cycle that can be executed in a vacuum processing chamber for debinding and sintering powder metal parts. The plot illustrates a ramp up 11001 in processing chamber temperature from an initial temperature (for example room temperature) to a debinding temperature 11002. In two stage debinding-sintering processes the parts can be debinded during a debinding cycle for a dwell time DT at a debinding temperature sufficient to remove binder from one or more parts in the processing chamber during which time binder byproducts can off gas from the parts. The parts processing temperature can then be ramped up 11003 to sintering temperature 11004 which can be maintained during a sintering cycle for a sintering time ST before cooling 11005 is initiated by controllably lowering the power and/or de-activating furnace heaters. It is to be emphasized that this disclosure relates generally to low cost to vacuum atmosphere and not atmospheric pressure. With respect to the descriptions for metal sintering it is to be emphasized that high purity is often desired during the sintering cycle and may or may not be important during debinding. For debinding (as opposed to sintering) it should be understood that the multi-step sintering systems and methods in this disclosure can be configured to operate during the debinding cycle at any pressure including vacuum, atmospheric or even slight positive pressure. The emphasis throughout these descriptions is upon sintering systems and methods that minimize or eliminate the presence of oxygen and debinder byproducts during sintering and only optionally eliminate oxygen (or other contaminants) during debinding. For example in the case of certain steels it may be acceptable for the chamber atmosphere to have high oxygen content during debinding but not during sintering. On the other hand for titanium and/or aluminum sintering it may in some cases be important to maintain ultra-low oxygen levels during debinding as well as during sintering. It must be further understood that in all cases within this disclosure that describe powder metal sintering, the debinding systems and methods described are configured such that the system and method can minimize and/or prevent condensation of debinding byproducts within the vacuum chamber and any portions or extensions of the vacuum processing chamber including inlet and outlet tubes. While the foregoing description focuses on a two-step process it should be appreciated that many variations are possible including a plurality of steps divided between multiple time spans and there are many possible variations in which debinding is performed prior to sintering and for which debinder byproducts can be eliminated or minimized to below a predetermined threshold. The forgoing description focuses on a simple example and in should be understood that in addition to multiple steps there can be cases where temperatures can be controlled to vary continuously in complex ways within a predetermined range throughout a given time span for example responsive to open and/or closed loop process controls. For example, in some cases debinding temperature can be feedback controlled to vary within a predetermined range responsive to continuously measured variations of pressure increase due to debinding. In many cases the predetermined threshold requires that there be no observable or measurable residue of debinder products within the chamber or the tubes at least during the sintering cycle. Applicants routinely achieve this threshold using the systems and methods described herein. Again, is to be yet further emphasized that for non-sintering applications and processes including semiconductor processing and other vacuum processing processes not related to metal sintering, the systems and methods described herein for achieving ultra-high purity and for reducing condensation of various contaminants can be applied.

FIG. 12 includes a schematic embodiment of a vacuum processing system including a vacuum processing chamber 12001 in which parts can be processed, furnace (or oven) heaters 12002, and thermal insulation 12003. The vacuum processing chamber 12001 includes a pumping tube 12004 having a pumping tube inlet 12005 and pumping tube outlet 12006 and the pumping tube 12004 can optionally be heated with a heater system 12007 which may be a tube heater and optionally insulated with tube insulation 12009 in order to eliminate and/or reduce condensation within the pumping tube 12004 of contaminants, including but not limited to debinder by-products, to a predetermined threshold. In many cases the predetermined threshold is simply that no visibly or nasaly detectable or otherwise humanly observable buildup of residue remains within the chamber or the tubes. Applicant routinely achieves this remarkable threshold result and additionally is often unable to chemically or microscopically measure any clear presence or influence of debinder byproducts within out-processed parts. Applicants knows of no other sintering furnace equipment that is able to achieve such a low threshold for condensation in all portions of the processing chamber and also simultaneously in pumping tubes during and therefore following debinding processes. The vacuum processing chamber 12001 can also include an inlet tube 12010 that can be heated with an inlet tube heating system 12011 and that can optionally be insulated with inlet tube insulation 12012. The inlet tube 12010 can be utilized for injecting process gas which in turn can contribute to serve as Peclet sealing sweep gas in one or both cases: (i) when it is exhausted through the pumping tube 12004 and/or (ii) when it contributes to sweep gas flow of a peclet tube seal at the outlet of a hermetic pump (not shown) such as the pumps systems of FIG. 6A-6C.

The embodiment of FIG. 12 can be operated in accordance with many different processes for many different purposes and applications where high purity and low condensation is desired. As described above the process gas can be injected into the vacuum processing chamber 12001 through one or more input tubes 12010 and depending on vacuum pressure and depending upon the diameter of the pumping tube 12004 the process gas may act as a sweep gas in the pumping tube 12004 to provide at least some degree of Peclet sealing. In many cases, as described above this Peclet sealing can achieve ppm or even ppb or better isolation between the outlet 12006 and the inlet 12005 of the pumping tube 12004. For example, Applicant routinely operates a ⅛″ to ⅜″ diameter pumping tube 8″ long with 1-3 slm of process gas flow to achieve ppm and ppb levels of purity. For various combinations of process gas flow rate, tube length, tube diameter and vacuum pressure, the pumping tube 12004 can provide for excellent Peclet sealing of parts per million or better and even parts per billion. For example, in the context of a 10 liter chamber Applicants routinely demonstrate Peclet sealing, of the inlet relative to the outlet, of ppm to ppb at chamber vacuum pressures in the range 5 torr-100 torr for a pumping tube having a ⅜″ Inner diameter pumping tube 8″ long and with 0.5-5 slm of process gas flow serving as the Peclet sweep gas. As described above in reference to FIGS. 7 and 8 it is readily possible to estimate Peclet sealing over these pressure ranges as long as conditions for laminar flow are maintained.

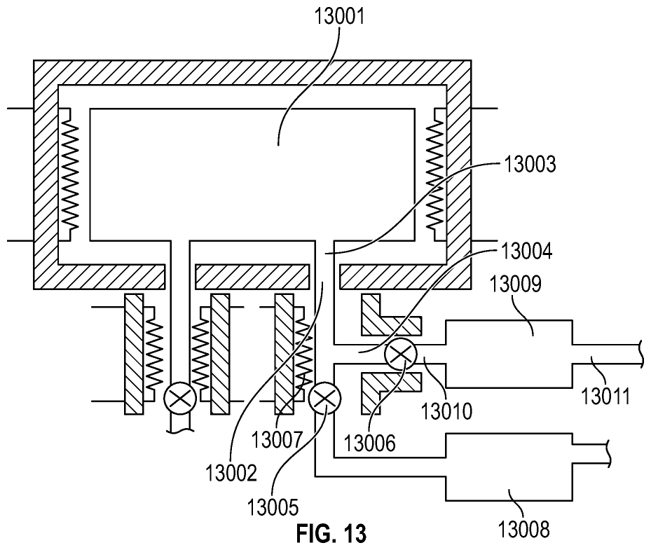

While the embodiment of FIG. 12 can be applied to many applications, Applicants recognize that it can provide for especially remarkable advantages in the context of two stage debinding and sintering applications for example in sintering of metals and/or ceramic powders including for aluminum sintering and titanium sintering. In various methods during debinding the chamber maintains debinding temperature while the pumping tube 12004 and/or the inlet tube 12010 can be simultaneously heated somewhat below, at, or even above debinding temperatures so as to prevent or reduce condensation of binder within the inlet tube 12010 and the pumping tube 12004. For a given binder material Applicant often empirically establishes a condensation threshold temperature for avoiding humanly observable (i.e. by eye, touch, and smell) condensation and sometimes that threshold temperature is below the actual debinding temperature. In such cases Applicant often controls one or more of the tube heaters to ensure that the tube temperature remains above that empirically established condensation threshold temperature. For example for certain binders Applicant performs the above mentioned lab tests for measuring condensation threshold temperature to be in a range between 300 C-400 C and then routinely debind various bound powder metal parts at debinding temperatures of 400 C-500 C with the pumping tube heated to a temperature between 300-400 C. In these cases Applicant has yet to detect evidence of any condensation whatsoever. In other cases the design threshold for overheating the tube connectors is greater than 500 C and Applicant employs air debinding at roughly 300 C while maintaining the tubes at or above this temperature to very thoroughly prevent condensation therein to within empirically established thresholds. This has enabled Applicant to provide for vacuum sintering of metals that are highly susceptible to oxygen as well binder contamination, including even sintering high quality Aluminum alloys. Remarkably Applicant has achieved excellent powder aluminum sintering at pressures between 10 Torr and 400 Torr using the 8″ pumping tube described above. Aluminum alloys are generally thought to be among the most sensitive and difficult to sinter metals at least for the reason that it oxidizes easily such that even ppm levels of oxygen tend to frustrate sintering. Our success at sintering aluminum alloys in these systems using these methods can be regarded as a testimony to the remarkable advantages thereof. It is noted that in many cases a low cost low performance and even a highly contaminated vacuum pump can be employed to pump on the outlet on the pumping tube and yet by following the guidelines described above with respect to FIGS. 7 and 8 it is possible to achieve ppm or even ppb and better Peclet isolation for vacuum pressures between 10 and 100 torr or higher. In cases where lower pressures or larger diameter tubes are needed or desired other embodiments such as that of FIG. 13 can be employed.

In some embodiments, the system of FIG. 12 operates as a furnace system for powder metallurgy with reduced contamination. The vacuum processing chamber 12001 is configured to perform a debinding cycle at a debinding temperature sufficient to debind at least one part such that debinding by-products are off-gassed from the least one part. The debinding cycle can be followed by a sintering cycle at a sintering temperature that is higher than the debinding temperature. The vacuum processing chamber 12001 has a pumping tube 12004 having an inlet end 12005 that is sealed to the vacuum processing chamber 12001 and an outlet end 12006 that is separated from the vacuum processing chamber 12001 by the pumping tube 12004. The heating system 12008 includes at least one heater configured to heat the pumping tube 12004 at least during the debinding cycle to at least a temperature sufficient to reduce condensation of contaminants within the pumping tube 12004, including the debinding by-products outgassed from the vacuum processing chamber 12001 during the debinding cycle, to a predetermined threshold. A pumping system 12013 is sealed to the outlet end 12006 of the pumping tube 12004 and is configured to produce a vacuum in the vacuum processing chamber 12001. A process gas source (not pictured in FIG. 12, but pictured in FIG. 6A) is configured to inject a sweep gas into the vacuum processing chamber 12001 at least during the sintering cycle such that the pumping tube 12004 provides an amount of Peclet sealing during sintering.

FIG. 13 illustrates an embodiment similar to that of FIG. 12 that can provide yet further advantages especially for multi-step processing including in the context of multi-step processes such as debinding-sintering furnaces. In this system the outlet of the pumping tube 13002 is sealed to a first heated debinding valve 13005 that is sealed to the inlet of a debinding pump 13008 and a heated sintering valve 13006 that can be sealed to the inlet of a sintering pump 13009 including but not limited to a low cost high purity pumping system as described previously with reference to FIGS. 6A, 6B and elsewhere throughout this application. In this embodiment the high temperature hot valves 13005 and 13006 can be heated by the same heater system 13007 that is relied upon to heat the pumping tube 13002. During debinding the heating of the pumping tube 13002 and the hot valves 13005 and 13006 substantially reduces and/or prevents condensation of binder by-products inside the pumping tube 13002 and inside the valves 13005 and 13006. Many variations are possible within the scope of this disclosure. For example two pumping tubes can be employed with the debinding hot valve sealed to the outlet end of a first pumping tube and the sintering hot valve sealed to the end of a second pumping tube.

This embodiment can provide benefits in many multi-step processing applications. For example, it can be configured to operate as a furnace system for metal powder metallurgy with reduced contamination. A vacuum processing chamber 13001 is configured to perform a debinding cycle at a debinding temperature sufficient to debind a part such that debinding by-products are off-gassed from the part. The debinding cycle can be followed a sintering cycle at a sintering temperature that is higher than the debinding temperature. The vacuum processing chamber 13001 has a pumping tube 13002 having an inlet end 13003 that is sealed to the vacuum processing chamber 13001 and an outlet end 13004 that is separated from the vacuum processing chamber 13001 by the pumping tube 13002. There is a first valve 13005 arranged as a debinding valve to be open during for debinding and a second valve 13006 arranged as a sintering valve to be opened during sintering, each of which is sealed to the outlet 13004 of the pumping tube 13002. A heating system 13007 includes at least one heater configured to heat the pumping tube 13004, the first valve 13005 and the second valve 13006 at least during the debinding cycle to at least a temperature sufficient to reduce condensation of contaminants within the pumping tube 13002 and within the first valve 13005 and the second valve 13006, including the debinding by-products outgassed from the vacuum processing chamber 13001 during the debinding cycle, to a predetermined threshold. A first vacuum pump system 13008 (a debinding pump) is arranged as a debinding pump to be pumping during debinding and is connected to the first valve 13005 (the debinding valve). The first vacuum pump 13008 is for pumping on the vacuum processing chamber 13001 during debinding through the pumping tube 13002 by way of the first valve 13005. A second vacuum pump system 13009 (a sintering pump) is connected to the second valve 13006 (the sintering valve). The second vacuum pump 13009 is for pumping on the vacuum processing chamber 13001 during sintering through the pumping tube 13002 by way of the second valve 13006. The second vacuum pumping system 13009 can include a second mechanical vacuum pump mechanism within a hermetic pump housing configured to hermetically isolate the second mechanical vacuum pump mechanism from ambient air outside the hermetic pump housing. The second vacuum pump system 13009 includes a second pump inlet 13010 connected to the second valve 13006 and a second pump outlet 13011. The second pump outlet 13011 can be hermetically sealed to an inlet of a Peclet seal tube in accordance with the above descriptions for example for FIGS. 6A-C. A sweep gas source is configured to inject a sweep gas into the second hermetic pump housing and or the inlet of the Peclet seal tube (as shown in FIG. 6B and FIG. 9). A process gas source may be configured to inject process gas into the vacuum processing chamber 13001 (as shown in FIG. 6A). The sweep gas flows through the Peclet seal tube from the inlet of the Peclet seal tube towards an outlet of the Peclet seal tube to substantially isolate against the backflow of the ambient air through the Peclet seal tube. A controller can be configured to, during at least a portion of the debinding process, cause the first valve 13005 to be in an open position and the second valve 13006 to be in a closed position and operate the first mechanical vacuum pump 13008 to produce a vacuum in the vacuum processing chamber 13001. During at least a portion of the sintering process, the controller is configured to cause the first valve 13005 to be in a closed position and the second valve 13006 to be in an open position and operate the second mechanical vacuum 13009 to produce a vacuum in the vacuum processing chamber 13001.

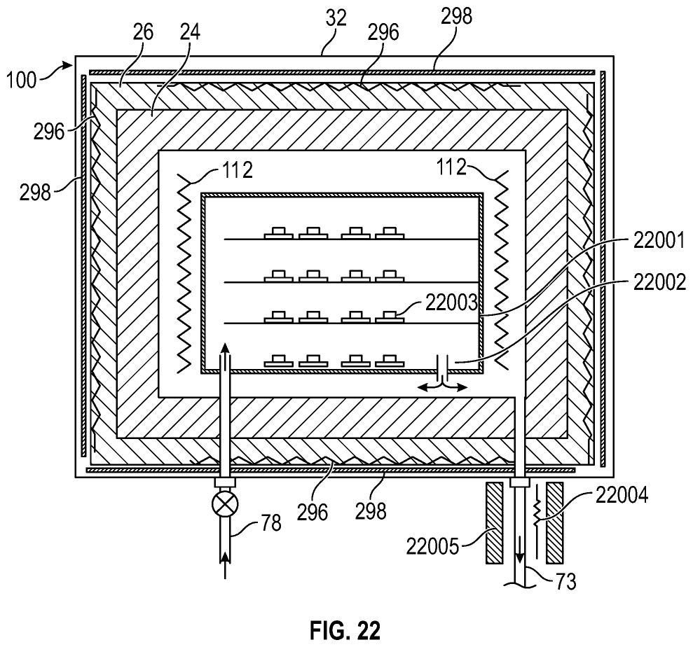

Applicants do not intend the forgoing embodiment (system and method) to be limiting and many variations are possible including for example the use of air debinding to “burn off” binder during debinding at atmospheric pressure in which case the same functional advantages are brought to bear including prevention of condensation and Peclet isolation during sintering. A person of ordinary skill in the art having the advantage of this description in hand can be expected to engineer many modifications to allow for different debinding cycles yet maintain the scope with respect to high purity and low condensates during sintering. Furthermore, as will be described later for example in reference to FIG. 22, the above described combination of a heated pumping tube with multiple heated valves and pumps can result in sweeping benefits when applied to a wide range of furnace and vacuum processing systems.

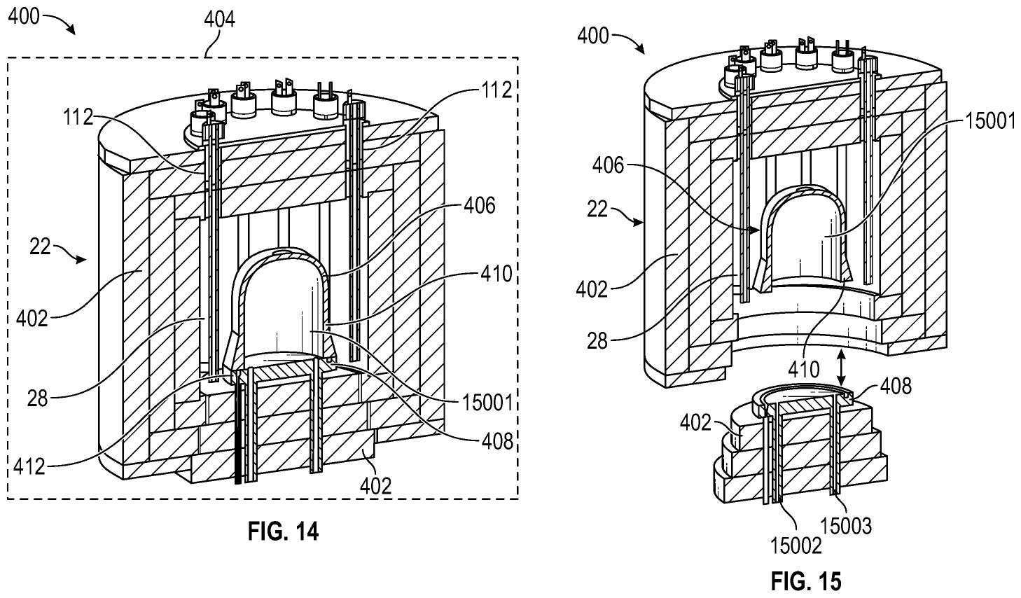

FIGS. 14 and 15 illustrate details with respect to one embodiment that can be applied to the systems of FIGS. 12 and 13. A furnace 400 includes heaters 112 and insulation 22. The furnace 400 can includes an optional protective cover 404 that could be merely a mechanical shield but can also optionally be arranged to be at least somewhat sealed for containing somewhat pure and somewhat oxygen free gas in the manner of a glove box and in some cases could be arranged as a somewhat sealed vacuum chamber. A hot zone 28 heats a vacuum retort 406 that includes a retort body 410, a retort base 408 and a retort seal 412.

The system is shown in the closed and sealed position in FIG. 14 and in the open position in FIG. 15 for loading and/or unloading parts. The system incudes a vacuum processing chamber 15001 with inlet 15002 and pumping tubes 15003 integrally sealed thereto by welding (in the case of metal chambers) and monolith bonding and/or forming in the case of ceramics. For example, Applicants routinely produce and utilize non-porous sintered SiC chambers in accordance with the design illustrated here that are routinely operated at temperatures up to 1500 C. Applicant can successfully sinter Aluminum alloys in low cost embodiments of FIGS. 14 and 15 using low cost ceramic for the chamber and/or low cost high temperature steel. It is emphasized that the processing chambers 150001 illustrated in FIGS. 14 and 15 can be arranged to serve as a vacuum chamber in the absence of any other external vacuum chamber. In these embodiments it can be advantageous that the chamber material should be non-porous and impermeable to gases especially outside air. In other embodiments as will be described in reference to FIG. 22 below, the same or similar structure would be utilized as a retort within an external vacuum chamber and it may be acceptable that the retort material can be somewhat porous and permeable within acceptable limits. In the foregoing embodiments the retort may serve as a partial vacuum chamber in cases where some pressure difference can be developed intentionally or otherwise between the inside and the outside of the retort. In yet other embodiments the chamber may serve as a vacuum chamber and can be surrounded by gas at atmospheric pressure with an external chamber that at least acts as a glove box for blocking oxygen from outside air.

In other embodiments at higher temperatures Applicant routinely sinters high quality titanium in an embodiment of FIGS. 14 and 15 using a SiC chamber (or retort) 406 with SiC heaters and high-grade high temperature insulation suitable for operation up to 1500 C. In particular Applicant has built multiple embodiments using sintered alpha phase SiC with chamber sizes in excess of 1.5 cubic feet. Applicant is presently preparing for the purchase of a system with a sintered alpha SiC chamber (or retort) according to the designs of FIGS. 14 and 15 having a 4 cubic foot volume therein as the vacuum processing chamber. Applicants have successfully pursued the purchase at reasonable cost of such chambers despite a great deal of advice that such parts could not and would not be available except at exorbitant and commercially impractical prices. In this regard Applicant considers that it is surprising as well as remarkable to demonstrate vacuum sintering furnaces in accordance with these descriptions that operate at 1500 C with volumes greater that 1.5 cubic feet. Furthermore, such furnaces, for example configured in accordance with FIGS. 14 and 15 having several cubic feet of volume can be expected to demonstrate sweeping technical and commercial advantages relative to conventional industrial sintering furnaces.

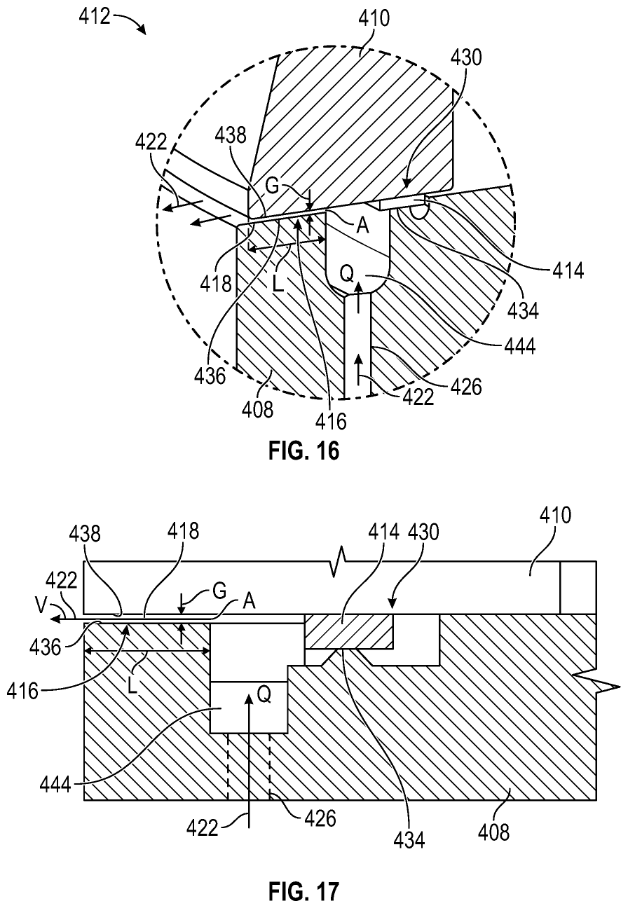

FIG. 16 illustrates a high temperature chamber seal that can be utilized in various embodiments herein including that of FIGS. 14 and 15. It is noted that the term retort and chamber are interchangeable in the context of these descriptions and in many applications Applicant routinely uses this retort as a vacuum chamber with no external vacuum chamber other than the retort itself. In such configurations the retort acts as a vacuum chamber and serves as the processing chamber 12001 and 13001 as represented in FIGS. 12 and 13. It is noted that the system of FIG. 14 and FIG. 15 can be operated as one embodiment of the systems and methods of FIGS. 12 and 13. A retort and/or vacuum chamber body 410 has a retort seal system 412 at a retort base 408. The retort and/or chamber seal 412 includes an inner seal 430 such as a high temperature gasket and an outer seal 416 such as the peclet gap seal illustrated in the figure. The high temperature gasket can be a gasket 414 against a gasket ledge 434 made of any gasket material (such as graphite foil or “graphoil” gasket material) that can withstand the intended maximum operating temperature of the furnace or oven. For example for metal sintering using a non-porous sintered alpha SiC chamber Applicant routinely utilizes graphoil at temperatures up to 1500 C or even higher in some cases. Graphoil gaskets tend to be leaky as compared to conventional elastomeric vacuum o-ring gaskets and Applicant has found it challenging to identify any extreme temperature gaskets that are cost effective and operate above 400 C without detectable and unacceptable leak rates. Applicant can compensate for the effects of gasket leakage on chamber purity by arranging for a double seal that includes an outer Peclet gap seal 416 that can provide for ppm or even ppb isolation such that outside air is isolated from the gasket such that the leak becomes inconsequential to purity within the chamber. Peclet gap seal operates in accordance to the principles described above in reference to FIGS. 7 and 8: a sweep gas tube 426 can inject sweep gas 422 into a channel 418 formed between defining faces 436 and 438 that allows the sweep gas to flow freely into the peclet gap from a chamber 446. This can ensure high purity within channel 444 such that the gasket leak does not effect the process at least for the reason that the leak only consists of highly pure oxygen free process gas. For example with a gap thickness 418 of 0.005″ and a sweep gas 422 flow of 2 slm of Argon Applicant routinely observes ppm and even ppb isolation for a gap width of roughly ½″ as will be described in greater detail with reference to FIG. 17.

FIG. 17 is a schematic of the previously described high temperature chamber and/or retort sealing arrangement including an inner gasket seal 414 and an outer Peclet gap seal 416 having a gap size G and a gap length L such that a cross sectional area A of the Peclet seal can be estimated as the product of groove 444 perimeter (circumferential for round chambers) times gap height G. Sweep gas 422 can be introduced by way of a hermetically sealed sweep gas feed tube 426 and such that the sweep gas flows into groove 444 and then through the Peclet gap to provide isolation with respect to outside atmosphere such as outside air. The principles and equations described with respect to the Peclet seal (FIGS. 7 and 8) are directly applicable with Area A being a cross sectional area of the gap perpendicular to the direction of sweep gas flow Q (gap size G multiplied by the circumference of the groove 444). As mentioned in the discussion with respect to FIG. 7 the gap here is defined by parallel surfaces 436 and 438. It is noted that the groove 444 can be arranged to have sufficient cross sectional area such that sweep gas enters the Peclet gap at approximately uniform pressure around the entire circumference (it is noted that for a thin gaskets of less than 0.030″ this condition will generally not be met without a groove). A person of ordinary skill in the art having this disclosure in hand can readily design a groove that provides for highly uniform feed pressure throughout the entire peclet gap.

In general applicants recognize that it can be difficult, costly and/or impractical to obtain or employ a single conventional vacuum sealing gasket for high temperature operation for temperatures above 300 C where elastomers tend to degrade and especially for temperatures above 400 C where even expensive and state of the art metal vacuum seals can begin to fail. However applicants recognize that imperfect “leaky” gaskets such as graphoil are readily available at low cost and Applicant developed the above high performance double seal arrangement in order to use a leaky gasket and nevertheless achieve ppm and even ppb isolation between the inside of a chamber and the surrounding atmosphere including but not limited to outside ambient air. For chambers having volumes between 0.25 cubic feet at 4 cubic feet Applicant can readily achieve ppm and even ppb chamber isolation using a peclet sweep gas between 1 to 5 slm a gap size of 0.003-0.012″ through the outer peclet gap seal.

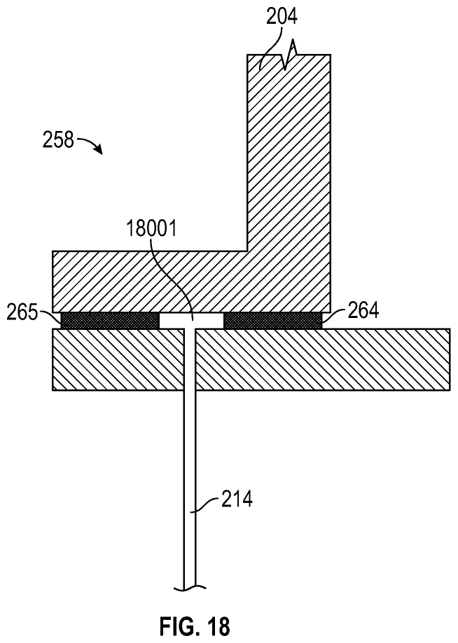

FIG. 18 schematically illustrates another embodiment of a seal arrangement with a retort and/or chamber body 204 and an extreme temperature double seal 258 including an inner gasket seal 264 and outer gasket seal 265 with a space 18001 therebetween that can employed for sweeping away at least some of any outside air, contamination or gas that leaks through the outer gasket into the gap. For example 1 slm of sweep gas (such as Argon or Nitrogen) can be introduced through a sealed tube 214 and pumped away from a separate tube (not shown) at an opposing side of the chamber. In another embodiment one or more tubes can be utilized for vacuum pumping of the gap to pump away at least some of any outside air, contamination or gas that leaks into the gap. It is noted that the inner and outer seals of FIG. 18 could be arranged within embodiments similar to of FIG. 16 and FIG. 7.

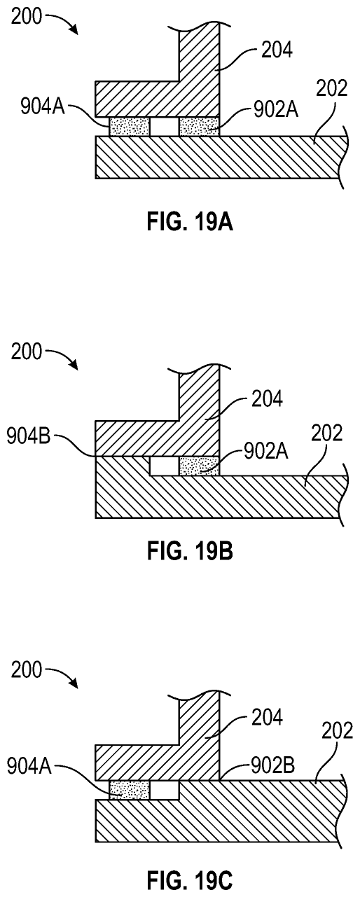

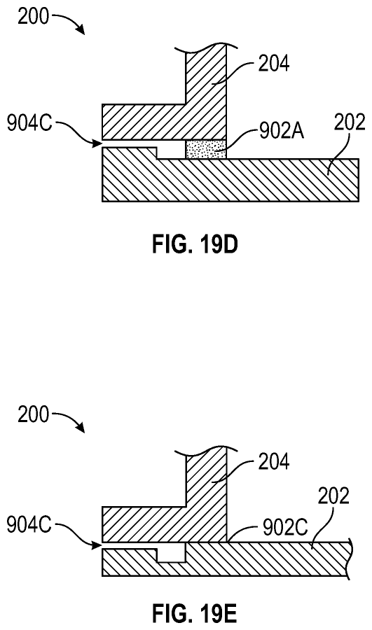

FIGS. 19A-19E are cross-sectional views of portions of exemplary retort and/or vacuum chamber configurations 200 that represent embodiments of double seals that may be implemented with a vacuum processing chamber to seal a retort body 204 to a base 202. In each of FIGS. 19A-19E, a left side represents an outside of the chamber, which may be any environment immediately surrounding the retort and/or vacuum processing chamber. In each of FIGS. 19A-19E, the seal on the right represents an inner seal (902A, 902B, 902C), and the seal on the left represents an outer seal (904A, 904B, 904C). In each of the exemplary configurations illustrated in FIGS. 19A-19E, the chamber may include a groove (not shown) (allowing sufficient conductance for sweep gas flow or vacuum pumping as described in FIG. 18) between the seals and/or the gaskets may be sufficiently thick (e.g., about 0.05 inch to about 0.1 inch) to create a space between the seals such that no groove is required. Contact seals often called “lap seals” may be formed by opposing surfaces in direct contact with one another. Lap seals may generally be formed by contact between surfaces that have been machined and/or ground to a relatively high degree of flatness. For example, in the case of metal chambers such as SiC chambers, flatness may be about 0.001 inches to about 0.0005 inches, about 0.001 inches to about 0.002 inches, etc. In the case of SiC or other ceramic retort materials, the flatness of lap seals or lap joints may be about 0.0001 inches to about 0.0005 inches, or about 0.0005 to about 0.0015 inches. It is emphasized that in all cases 19A-19E a sweep gas or vacuum pumping can be applied as described with reference to FIG. 18.

As shown in FIG. 19A, inner seal 902A and outer seal 904A may each be gasket seals. With reference to FIG. 19B, inner gasket seal 902A may be combined with an outer lap seal 904B. FIG. 19C illustrates an inner lap seal 902B positioned inwardly with respect to an outer gasket seal 904A.

FIG. 19D illustrates an inner gasket seal 902A positioned inwardly of an outer Peclet gap seal having a Peclet gap 904C in accordance with the Peclet seals described above (e.g., with respect to FIGS. 14-17). FIG. 19E illustrates an inner lap seal 902C positioned inwardly with respect to Peclet gap 904C. Regarding the configurations of FIGS. 9D and 19E, Peclet sweep gas may be applied in the groove or space in accordance with previous descriptions of Peclet sealing. In each configuration including a gasket (e.g., gasket 902A, 904A), the gasket may be a graphoil gasket or another suitable high-temperature gasket, such as ceramic felt or fiber. Although not illustrated, here one or more additional outer seals may be included to form a third, a fourth (or more), inner and/or outer seals.

Having discussed techniques for providing hermetic sealing at extreme for example in ranges between 300 C and 500 C as well as 500 C-1500 C, it is noted that the high temperature sealing techniques described above and those described below with respect to high performance tube furnaces can also be employed for providing ceramic tube to metal seals and/or metal tube to metal seals for example at the outlet end of the pumping tube. Scaled down smaller diameter designs are routinely being employed by the Applicant to seal the ends of both the inlet and outlet tubes as well as the outer end of the peclet feed tubes. The same designs and principles are found to scale down and miniaturize easily such that 1″ diameter to 2″ diameter tube seals are routinely and successfully produced for example using an inner graphoil seal and an outer Peclet gap seal. It is noted that the amount of sweep gas required to achieve ppm or ppb and better performance tends to be very low compared to the sweep gas requirements for the chamber seal, and Applicant routinely provides for state of the art leak free joints passing at <1E-10 torr liters/sec of Helium leak rate and Applicant routinely does so using only 0.1 slm of sweep gas. It is further noted that Applicant routinely fabricates high temperature valves (for example the hot valves in FIG. 13) that are built of all metal and ceramic construction. Commercial high temperature valves typically avoid the use of elastomers in and around the valve seat and often they include a very long valve stem with an elastomeric seal that is spatially distance from the hot valve seat and operates at temperatures under 300 C. Such high temperature valves are readily available and can be custom designed by persons skilled in the art of valve design and fabrication.

Applicants recognize that the techniques described above can be utilized to great advantage by modifying various conventional furnaces to add the features described herein. For example, as will be described immediately below, remarkable performance advantages can be achieved by applying these teachings to otherwise conventional tube furnaces.

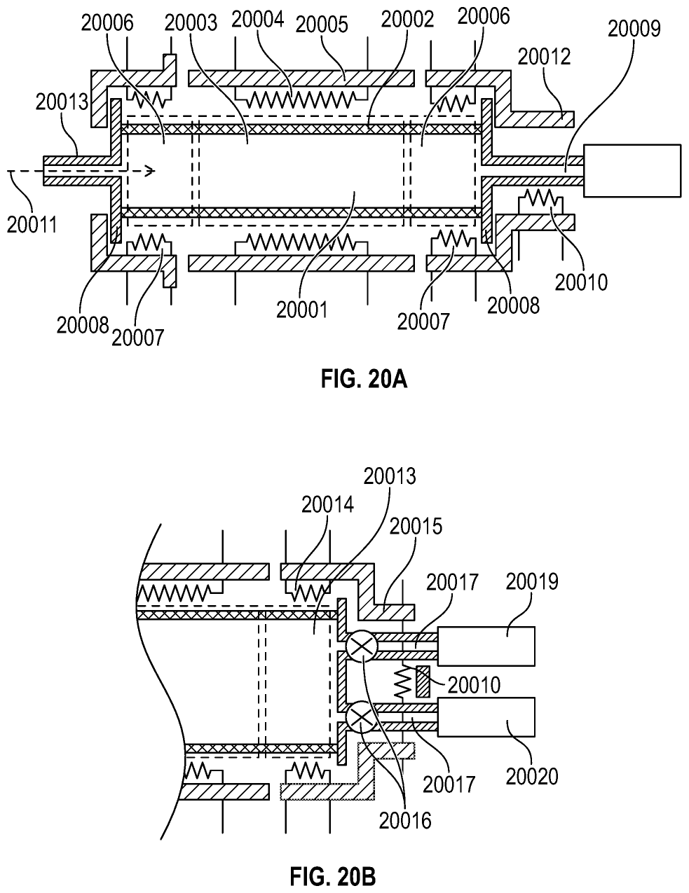

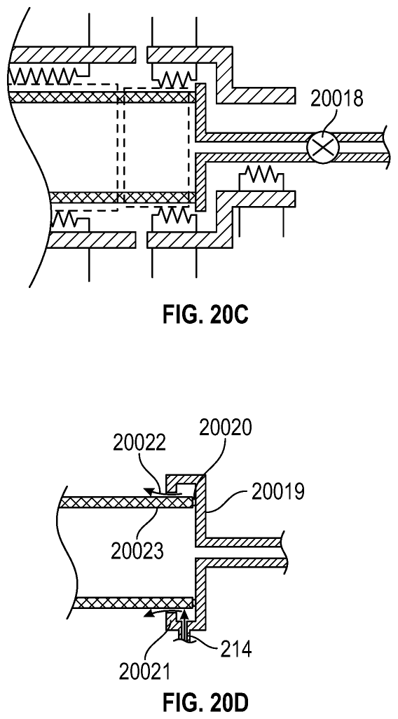

FIG. 20A illustrates an embodiment of an advanced high-performance high-purity processing chamber based in part on tube furnace technology that can be useful in many applications including but not limited to two stage debinding and sintering applications (i.e. FIG. 11). The system includes a vacuum processing chamber 20001 within a ceramic or metal tube 20002 spanning a central tube portion 20003 that is surrounded by furnace heaters 20004 and furnace insulation 20005 with chamber extensions 20006 extending in two directions (for double ended tube furnaces) having the same or similar cross sectional shape and area as the vacuum processing chamber 20001. For the case of a tube furnace the cross-sectional area and shape is substantially the same give or take a degree of distortion intentioned or otherwise in the tube. Applicant has operated such tube furnaces with one or two additional extension heater systems 20007 surrounding one or both ends of the processing chamber that can heat the chamber extensions 20006 at one or both ends at least during debinding to prevent or at least reduce contamination of binder by products within the chamber extensions including one or more sealed end caps 20008. The extension heaters 20007 can heat the extensions 20006 and end caps 20008 based on the principles previously described in reference to tube heaters for heating pumping tubes, to prevent or at least minimize condensation therein of debinder byproducts below a predetermine threshold. These measures can ensure cleanliness at least with respect to debinder byproducts, after debinding and during sintering, of the atmosphere within the vacuum processing chamber. As was described previously with respect to FIGS. 12 and 13, the furnace can include an outer pumping tube 20009 that is configured in accordance with above teachings such that it can be heated with a pumping tube heater 20010 and optionally surrounded by tube insulation 20012 in order to prevent or reduce contamination of binder products during debinding. Furthermore, as was the case in those embodiments, the pumping tube 20009 can be configured with sufficiently small diameter and long enough length to provide for a at least some predetermined degree (based at least on principles and teachings of FIGS. 7 and 8) of Peclet sealing provided sufficient flow of process gas 20011 is injected in the inlet tube 20013 of the system. In the context of the previous descriptions (for example FIGS. 12 and 13) the arrangement of FIG. 20A can be regarded as a furnace system with the processing chamber (in this embodiment central to the tube) transitioning to chamber extensions 20006 (in this case at the inlet and outlet) having the same or similar cross sectional area as the central tube portion 20003 and the chamber extensions 20006 can be heated by a heating system 20007 configured to heat them at least during debinding to prevent condensation therein including within the caps. While conventional tube furnaces are routinely employed for powder metallurgy including for debinding as well as sintering, commercially available tube furnaces are typically prone to contamination by air as well as by binder byproducts. Applicant has shown that the configuration of FIG. 20A can be configured with respect to pumping tube and/or using multiple hot valves with separate debinding and sintering pumps, to provide the same remarkable advantages described previously with respect to the furnace embodiments configured according to FIGS. 6A-C, 9-10 and 14-17 many of the advantages including but not limited to high purity atmosphere and low oxygen content, despite the use of low cost vacuum pumping systems and/or mechanisms, and minimal condensation of binder. For example the extension heater systems 20007 and the tube heater system 20010 can be kept at, near or above debinding temperature to prevent or reduce condensation of binder byproducts and the pumping tube 20009 can be configured such that process gas 20011 injected at the inlet tube can provide for a predetermined degree of Peclet sealing for achieving ppm or even ppb or better purity. As was the case in previous embodiments the central tube portion 20003 can be controlled to operate during sintering at much higher temperatures than the extensions 20006 as the inlet tube 20013 and pumping tube 20009.

In one method power to the extension heaters 20007 and the tube heater(s) 20010 can be deactivated or controllably reduced after debinding as the central tube portion 20003 ramps up to sintering temperature such that the extensions 20006 and tube(s) remain at or below the temperature they were held to during debinding. These high performance tube furnaces can demonstrate remarkable utility when they are employed as low cost process development furnaces

FIG. 20B illustrates an embodiment of an advanced high performance tube furnace which could be a tube furnace wherein an extension 20013 of the furnace chamber can be heated with an extension heater 20014 with optional insulation 20015 surrounding it and high temperature tolerant all metal and or metal and ceramic valves 20016 which lead to a first vacuum pump system 20019 and second vacuum pump system 20020 (which can be as previously described a pump for debinding and a separate pump for sintering). It is noted that the high temperature valves 20016 can be sealed at the inlet end of the pumping tubes 20017, the outlet ends, or at various points between the inlets and outlets of the pumping tubes 20017. Pumping tubes 20017 can be heated at least during debinding by tube heaters 20010. Applicants appreciate that the inclusion of a processing chamber extension 20013 allows the one or more end caps to be utilized at much lower temperatures as compared to the processing chamber thus allowing the valves 20016 to be integral or in close proximity to the end cap. For purposes of descriptive clarity FIG. 20C indicates an embodiment wherein a valve 20018 is located towards the outlet end of a pumping tube.

The above advanced tube furnace embodiments are intended for descriptive purposes and are not intended as being limiting. These systems and methods can be applied to provide advanced high performance tube furnaces based on many variations including for example vertically oriented single ended tube furnaces. With ongoing reference to FIG. 20B it should be appreciated that not all tube furnaces are double ended nor are they always oriented in a horizontal orientation. For example a tube furnace may be single ended with only one end cap and the opposing end of the tube can be closed and can be closely proximate to or fully contained within the processing chamber insulation such that the lose end forms part of the processing chamber. Applicant recognizes that single ended tube furnaces can be configured to be operated in any orientation vertical, horizontal or otherwise, in full accordance with the teachings herein for example with one of the tubes in FIG. 20B being utilized as an inlet tube and another one being utilized as a pumping tube.

FIG. 20D illustrates an end cap 20019 that can be configured with an extreme temperature double seal to provide for high temperature sealing above the maximum temperature limits of typical commercially available elastomeric seals. An inner high temperature gasket seal 20020 such as a graphoil seal can be combined with an outer peclet gap seal 20021 in accordance with the principles described in reference to FIGS. 16 and 17. Sweep gas 20022 can be fed using a feed tube 214 into the end cap to feed a peclet gap seal 20021. Various other high temperature double seals can be implemented with an end cap including but not limited to the variations described in FIG. 19A-19E. It should be understood that double seals need not be each located in one coplanar surface. For example any inner seal could sealably engage the tube face or even on the inside surface of a tube and any given outer seal could sealably face and/or engage the end face or an outer surface of the tube end. For example the inner seal 20020 of FIG. 20D is a gasket that faces and sealably engages the end face of tube 20023 and the outer seal 20020 is a peclet gap seal that faces the outer surface of the tube end, each of the double seal embodiments of FIGS. 19A-19E can be oriented accordingly.

With ongoing reference to FIG. 20D it is again noted that the high temperature sealing techniques described immediately above with respect to high performance tube furnaces can also be employed for providing ceramic tube to metal seals and/or metal tube to metal seals for example at the outlet end of the pumping tube. Scaled down smaller diameter designs based on the foregoing figure are routinely being employed to seal metal tubes and or valves to the ends of both the inlet and outlet tubes as well as the outer end of any sweep gas feed tubes. The same designs and principles are found to scale down favorable such that 1″ diameter to 2″ diameter tube seals are routinely and successfully produced for example using an inner graphoil seal and an outer peclet gap seal.

With respect to the forgoing descriptions and embodiments Applicant appreciates that persons of ordinary skill typically utilize expensive high performance ultra-high vacuum pumps in applications that require ultra-high purity especially ppm or ppb and better. For example typical systems designed for high purity processing (ppm, ppb or better) often employ expensive high compression turbo molecular pumps having compression ratio for oxygen (i.e. Compression C>1E6 or even C>1E8 in some cases), diffusion pumps, ion pumps or cryopumps. Such high vacuum pumps generally having much higher cost as compared to the high purity pumping and processing systems and methods described herein. Applicants have discovered that in some cases, contrary to conventional intuition and rules of thumb, the use of high and ultra-high vacuum can create additional unanticipated and even surprising problems resulting in inferior and/or compromised processes as compared to the systems and methods herein. For example various practitioners have sought to sinter titanium using ultra high vacuum and in some cases this imposes process challenges and compromises in part due to the increased rate of diffusivity of within the system of whatever residual contaminants are present. In other words high vacuum pumps can sometimes cause systems to exhibit greatly heightened to small trace quantities of contamination in comparison to the systems described herein. Thus, counter to common beliefs and intuition of persons of ordinary skill, when high purity is demanded there are cases where surprisingly superior performance can be achieved at higher pressure than is typically associated with high vacuum technology and products. For example Applicant has discovered, remarkably, that for high purity sintering of aluminum and titanium there can be great benefits to sintering at pressures of 1 torr or greater while on the other hand other practitioners often espouse the processing of these materials at pressures of 0.001 torr or even much lower. Applicants have discovered that the systems and methods described above, including but not limited to embodiments of FIGS. 12, 13, 14, 15 and 20A-D can provide for sweeping advantages as compared to high vacuum low pressure (<0.1 torr) when sintering aluminum, aluminum alloys, Titanium, high carbon steel alloys and many other sensitive and difficult-to-sinter metals and alloys. In particular Applicant routinely sinters aluminum alloys and titanium alloys in furnaces configured in accordance with all of these embodiments.

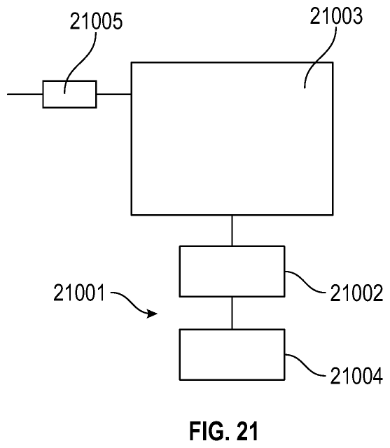

FIG. 21 illustrates an embodiment of a vacuum processing system that utilizes a two-stage pumping system 21001 for achieving ultra high purity at low cost. This system could be employed in a variety of applications including but not limited to semiconductor processing systems including but not limited to sputtering and etching plasma processing systems. In this embodiment a low cost low performance and/or extremely rugged but still low cost turbo molecular pump 21002 having unusually poor compression can be disposed between a vacuum processing chamber 21003 and a low cost high purity mechanical pump 21004 as described previously including a hermetically sealed mechanical pump having a peclet seal at the outlet with sweep gas flowing therethrough. This embodiment can achieve ultra-high purity at lower cost than traditional multistage systems at least for the reason that the turbo pump can have a very poor compression ratio and yet the system can nevertheless achieve ultra-high purity including parts per billion or better. The use of the low-cost high purity mechanical pumping system 21004 can enable the use of a lower cost “de-rated” turbo molecular pump 21002 having a compression ratio of less than 1E6, less than 1E5, less than 1E4, or less than 1E3. For example, this embodiment could be configured as a sputtering system that operates at 1E-4 torr and ppb purity could be achieved even if the low compression turbo pump only exhibits a compression ratio of 1000 or even 100 with respect to Oxygen. Conventional turbo pumps are readily available having compression ration of 10E8, 10E9 and even greater and applicants recognize that such high compression ratio's can result in very high cost and yet they are considered desirable in order for achieving ultra high purity. Applicants further recognize that derated turbo pumps can be designed with lower mechanical precision of internal mechanisms and superior ruggedness and reliability as compared to state of the art high compression pumps. It is noted that processing gas may be optionally introduced into the vacuum processing chamber 21003 via a process gas source 21005 and may contribute to the peclet sweep gas in accordance with previous descriptions. It is further noted that sweep gas can be injected into the pump housing and/or the inlet of the peclet tube as in previous descriptions with respect to low cost high purity mechanical pump systems.

As mentioned previously above, the systems and methods described herein can be adapted to provide for sweeping benefits even when retrofitted into many furnace embodiments. FIG. 22 depicts a vacuum sintering furnace 100 having inner insulation 24 and outer insulation 26 within vacuum chamber wall 32. Furnace 100 can include outer external heater 298 and/or outer heater systems 296 that can be embedded in the insulations configured to heat the outer insulation 26. Both options for outer heaters are included here and applicant have had success with both choices. Furnace 100 includes inner heaters 112, an inlet tube 78 and a pumping tube 73. The steel chamber containing high temperature insulation surrounding furnace heaters arranged for heating a sealed or semi sealed parts retort such as a ceramic, refractory metal or graphite retort that could be non-porous or somewhat porous. It is noted that in the context of FIG. 22 the retort does not generally need to serve as a vacuum chamber at least in cases where the outer chamber 32 is serving that purpose. In some embodiments the inlet tube 78 may be used to inject process gas and the sealed, or semi sealed and/or semi porous retort 22001 may include a retort pumping tube 22002 that can receive at least a portion of the process gas flow to pump the retort 22001 and to provide at least some degree of Peclet sealing between the outside and the inside of the retort. This Peclet sealing by the retort pumping tube can provide a degree of isolation against ingress to the retort of any air or other contaminants that may be present in the steel chamber and outside the retort. The system can include additional outer heater systems 296 and or 298 including heaters 296 embedded in outer layers of the insulation or can be placed as heaters 298 outside the insulation. In some embodiments the outer heater systems 298 could be installed just outside the vacuum chamber. These outer heaters can be activated at least during debinding of parts 22003 to maintain the outer insulation 26 at sufficiently high temperatures to reduce or prevent binder condensation on the insulation and on the inside to the vacuum chamber. Furthermore the vacuum chamber pumping tube 73 can be heated at least during debinding with a pumping tube heater 22004 and insulated with optional tube insulation 22005. Applicant has observed that furnaces having insulation and no outer heaters within a sealed vacuum chamber as illustrated in FIG. 22 can be prone to heavy binder condensation on the outside of the insulation and on the inside of the vacuum chamber, and Applicant has installed outer heaters in various embodiments (embedded in the insulation, outside the insulation on either inside or outside of the vacuum chamber wall). In various methods the outer heaters and/or pumping tube heaters are controlled in conjunction with the furnace heaters such that the outer insulation and/or pumping tube is heated during debinding to sufficient degree to greatly reduce condensation during debinding of debinder byproducts, and this use of outer heaters results in substantially improved part quality. Applicant has successfully utilized the valve, pump and pumping tube of FIG. 13 in conjunction with the chamber embodiment of FIG. 22. Various combinations of the features and methods of that combination has provided sweeping benefits for atmospheric purity in retort 22001. Applicant has implemented this combination in the context of many systems including vacuum sintering furnaces that employ water cooling during sintering of chamber wall 32. In that configuration Applicant has purged the water cooling lines prior to and during debinding such that the chamber wall is heated during debinding to reduce or eliminate condensation of binder by products during debinding. In some embodiments applicant installed conventional water cooled sintering furnaces and retrofitted the system with the heated pumping tubes of FIG. 12 and the semi sealed retort 22001 and retort pumping tube 22002 and has operated during sintering with sufficient process gas flow to achieve a high degree of Peclet sealing with the retort pumping tube 22002. In that combination Applicant was able to achieve exceptionally high atmospheric purity as compared with operation of the as received conventional sintering furnace. In another embodiment Applicant yet further modified the furnace to include the heated pumping tube and the two heated valves as in the embodiment of FIG. 13 and installed and used the two pumps separately during debinding and sintering and thus achieved yet further advantages allowing Applicant to sinter parts with superior metallurgical properties as compared to the parts sintered in the as-installed conventional furnace. The combination of the chamber of FIG. 22 and the features therein in combination with the vacuum manifold of FIG. 13 including the heated pumping tube and the two heated valves and two separate pumps has demonstrated remarkable benefits especially with regard to preventing condensation of binder byproducts.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed:

1. A pumping system with reduced contamination, comprising:
a vacuum pump system including a mechanical vacuum pump mechanism within a hermetic pump housing configured to hermetically isolate the mechanical vacuum pump mechanism from ambient air outside the hermetic pump housing;
a pump inlet hermetically sealed to the hermetic pump housing and configured to serve as an inlet path to the vacuum pump mechanism;
a pump outlet hermetically sealed to the hermetic pump housing and configured to serve as an outlet path from the mechanical pump mechanism;
wherein the vacuum pump system is configured to produce a vacuum in a vacuum processing chamber;
wherein the pump outlet is hermetically sealed to an inlet of a Peclet seal tube; and
at least one of: (1) a sweep gas source configured to inject a sweep gas into at least one of (i) the hermetic pump housing and (ii) the inlet of the Peclet seal tube; and (2) a process gas source configured to inject a process gas into the vacuum processing chamber; such that at least one of the sweep gas and a process gas flow through the Peclet seal tube from the inlet of the Peclet seal tube towards an outlet of the Peclet seal tube to substantially isolate against the backflow of the ambient air through the Peclet seal tube.

2. The pumping system of claim 1 wherein the sweep gas includes at least one of argon, nitrogen and a combination of nitrogen and hydrogen.

3. The pumping system of claim 1 wherein the gas source is configured to inject at least a portion of the sweep gas directly into the hermetic pump housing.

4. The pumping system of claim 1 wherein at least a portion of the process gas is injected into the vacuum processing chamber and flows into the vacuum pump system through the pump inlet.

5. The pumping system of claim 1 wherein the gas source is configured to inject at least a portion of the sweep gas into the inlet of the Peclet seal tube.

6. The pumping system of claim 1 wherein the vacuum pump system includes a ballast volume arranged in gaseous communication with the inlet of the Peclet seal tube such that the ballast volume can reduce pressure fluctuations caused by pump ripple.

7. The pumping system of claim 1 wherein the mechanical vacuum pump mechanism is a displacement pump and wherein a motor outside the hermetic pump housing is coupled to the displacement pump inside the hermetic pump housing via a hermetic rotary coupler.

8. The pump system of claim 7 wherein the hermetic rotary coupler is a magnetic hermetic rotary coupler.

9. The pumping system of claim 1 wherein the vacuum pump system has a base pressure selected from the group consisting of 0.001 Torr to 1 Torr, 1-10 Torr, 10-100 Tor, 100-300 Torr and 300-750 Torr.

10. The pumping system of claim 1 wherein the Peclet seal tube is a metal Peclet seal tube.

11. The pumping system of claim 1 wherein the outlet of the Peclet seal tube includes a valve configured to seal the Peclet seal tube from the ambient air at times when the sweep gas input is not flowing.

12. The pumping system of claim 1 wherein the mechanical vacuum pump mechanism is a displacement pump selected form the group consisting of a piston pump, a diaphragm pump and a scroll pump.

13. The pumping system of claim 1 further comprising:
a first stage vacuum pump disposed between the chamber and the mechanical vacuum pump mechanism such that an inlet of the first stage pump provides vacuum withing the vacuum processing chamber and the mechanical vacuum pump mechanism is configured to pump on an outlet of the first stage vacuum pump.

14. The pumping system of claim 13 wherein the first stage vacuum pump is a turbomolecular pump having an oxygen compression ratio selected from the group consisting of less than 1E6, less than 1E5, less than 1E4 and less than 1E3.

15. A furnace system for powder metallurgy with reduced contamination, comprising:
a vacuum processing chamber configured to perform a debinding cycle at a debinding temperature sufficient to debind at least one part such that debinding by-products are off-gassed from the least one part, wherein the debinding cycle can be followed by a sintering cycle at a sintering temperature that is higher than the debinding temperature, the vacuum processing chamber having a pumping tube having an inlet end that is sealed to the vacuum processing chamber and an outlet end that is separated from the vacuum processing chamber by the pumping tube;
a heating system including at least one heater configured to heat the pumping tube at least during the debinding cycle to at least a temperature sufficient to reduce condensation of contaminants within the pumping tube, including the debinding by-products outgassed from the vacuum processing chamber during the debinding cycle, to a predetermined threshold;
a pumping system sealed to the outlet end of the pumping tube and configured to produce a vacuum in the vacuum processing chamber; and
a process gas source configured to inject a sweep gas into the vacuum processing chamber at least during the sintering cycle such that the pumping tube provides an amount of Peclet sealing during sintering.

16. The furnace system of claim 15 wherein the vacuum is greater than 10 Torr and the pumping tube has a diameter selected from the group consisting of less than ¼″, less than ½″ and less than 1″.

17. The furnace system of claim 16 wherein the sweep gas flow is injected at a rate selected from the group consisting of 0.1 slm to 1 slm, 1 slm to 10 slm and greater than 10 slm.

18. The furnace system of claim 15 wherein pumping system includes:
a vacuum pump system including a mechanical vacuum pump mechanism within a hermetic pump housing configured to hermetically isolate the mechanical vacuum pump mechanism from ambient air outside the hermetic pump housing;
a pump inlet hermetically sealed to the hermetic pump housing and configured to serve as an inlet path to the vacuum pump mechanism;
a pump outlet hermetically sealed to the hermetic pump housing and configured to serve as an outlet path from the mechanical pump mechanism;
wherein the vacuum pump system is configured to produce a vacuum in a vacuum processing chamber;
wherein the pump outlet is hermetically sealed to an inlet of a Peclet seal tube; and
a sweep gas source configured to inject a sweep gas into at least one of (i) the hermetic pump housing and (ii) the inlet of the Peclet seal tube and such that the sweep gas and a process gas flow through the Peclet seal tube from the inlet of the Peclet seal tube towards an outlet of the Peclet seal tube to substantially isolate against the backflow of the ambient air through the Peclet seal tube.

19. The furnace system of claim 15 further comprising:
a first stage vacuum pump disposed between the chamber and the mechanical vacuum pump mechanism such that an inlet of the first stage pump provides vacuum withing the vacuum processing chamber and the mechanical vacuum pump mechanism is configured to pump on an outlet of the first stage vacuum pump.

20. The pumping system of claim 19 wherein the first stage vacuum pump is a turbomolecular pump having an oxygen compression ratio selected from the group consisting of less than 1E6, less than 1E5, less than 1E4 and less than 1E3.

21. The furnace system of claim 15 wherein the chamber is extended by way of a chamber extension having a cross sectional area substantially the same as a cross sectional area of the vacuum processing chamber and the inlet end of the pumping tube is connected to the process an outer end of the chamber extension.

22. The furnace system of claim 21 wherein the chamber extension includes a heating system configured to heat the chamber extension at least during a debinding process.

23. A furnace system for metal powder metallurgy with reduced contamination, comprising:
a vacuum processing chamber configured to perform a debinding cycle at a debinding temperature sufficient to debind at least one part such that debinding by-products are off-gassed from the least one part, wherein the debinding cycle can be followed a sintering cycle at a sintering temperature that is higher than the debinding temperature, the vacuum processing chamber having a pumping tube having an inlet end that is sealed to the vacuum processing chamber and an outlet end that is separated from the vacuum processing chamber by the pumping tube;
a first valve and a second valve each of which is sealed to the outlet of the pumping tube;
a heating system including at least one heater configured to heat the pumping tube and the first valve and the second valve at least during the debinding cycle to at least a temperature sufficient to reduce condensation of contaminants within the pumping tube and within the first valve and the second valve, including the debinding by-products outgassed from the vacuum processing chamber during the debinding cycle, to a predetermined threshold;
a first vacuum pump system, connected to the first valve, for pumping on the vacuum processing chamber during debinding through the pumping tube by way of the first valve,
a second vacuum pump system, connected to the second valve, for pumping on the vacuum processing chamber during sintering through the pumping tube by way of the second valve, the second vacuum pumping system including a second mechanical vacuum pump mechanism within a hermetic pump housing configured to hermetically isolate the second mechanical vacuum pump mechanism from ambient air outside the hermetic pump housing, the second vacuum pump system further having a second pump inlet connected to the second valve and a second pump outlet;
wherein the second pump outlet is hermetically sealed to an inlet of a Peclet seal tube; and
at least one of: (1) a sweep gas source configured to inject a sweep gas into at least one of (i) the hermetic pump housing and (ii) the inlet of the Peclet seal tube; and (2) a process gas source configured to inject a process gas into the vacuum processing chamber; such that at least one of the sweep gas and a process gas flow through the Peclet seal tube from the inlet of the Peclet seal tube towards an outlet of the Peclet seal tube to substantially isolate against the backflow of the ambient air through the Peclet seal tube; and
a controller configured to, during at least a portion of the debinding process, cause the first valve to be in an open position and the second valve to be in a closed position and operate the first mechanical vacuum pump to produce a vacuum in the vacuum processing chamber, and, during at least a portion of the sintering process, cause the first valve to be in a closed position and the second valve to be in an open position and operate the second mechanical vacuum to produce a vacuum in the vacuum processing chamber.

24. A method of operating a pumping system to reduce contamination, comprising:
operating a mechanical vacuum pump to produce a vacuum in a vacuum processing chamber, wherein the mechanical vacuum pump is contained within a vacuum pump housing hermetically sealing the mechanical vacuum pump from an ambient air;
wherein a pumping tube hermetically connects the vacuum processing chamber to a pump inlet of the vacuum pump housing;
wherein a pump outlet hermetically connects the vacuum pump housing to an inlet of a Peclet seal tube; and
operating a sweep gas source to inject a sweep gas into at least one of the hermetically sealed vacuum pump housing and the inlet of the Peclet seal tube, whereby the sweep gas isolates pump outlet, pump inlet and vacuum processing chamber against the backflow of the ambient air through the Peclet seal tube.

25. The method of claim 24 further comprising the step of heating the pumping tube to at least a temperature sufficient to reduce the condensation of contaminants outgassed from the vacuum processing chamber to the pumping tube to a predetermined threshold.

26. The method of claim 24 wherein the vacuum pump system provides an isolation in the pumping tube relative to the pump outlet selected from the group consisting of less than parts per million, less than parts per 10 million, less than parts per billion and less than parts per 10 billion.

27. The method of claim 24 wherein the vacuum pump housing has a hermicity selected from the group consisting of less than 10⁻⁷ cc/sec, less than 10⁻⁸ cc/sec and less than 10⁻⁹ cc/sec.
